(19) United States
(12) Patent Application Publication
(10) Pub. No.: US 2021/0197228 A1
(43) Pub. Date: Jul. 1, 2021

(54) MULTILAYER COATING FILM, AND METHOD FOR FORMING MULTILAYER COATING FILM

(71) Applicant: KANSAI PAINT CO., LTD., Hyogo (JP)

(72) Inventors: Natsuko NAKANO, Kanagawa (JP); Masashi KANDA, Kanagawa (JP); Kodai KITANO, Kanagawa (JP)

(73) Assignee: KANSAI PAINT CO., LTD., Hyogo (JP)

(21) Appl. No.: 17/056,840

(22) PCT Filed: May 10, 2019
(86) PCT No.: PCT/JP2019/018665

§ 371 Date: Nov. 19, 2020

(30) Foreign Application Priority Data
May 23, 2018 (JP) 2018-099080

(51) Int. Cl. B05D 1/36; B05D 5/06; B32B 27/20

(52) U.S. Cl. CPC B05D 1/36; B32B 27/20; B05D 5/06

(57) ABSTRACT

Provided is a multilayer coating film including a metallic base coating film and a transparent colored coating film that contains a blue pigment and that is disposed on the metallic base coating film, wherein the value of hue angle h in an L*C*h color space diagram of the multilayer coating film is within the range of 225° to 300°, and when X=C*45/L*45 and Y=[(L*15)²+(C*15)²)]^{1/2}+[(L*25)²+(C*25)²)]^{1/2}, X is 2 to 20 and Y is 50 to 250, provided that C*15, C*25, and C*45 each represent a chroma of the multilayer coating film calculated from a spectral reflectance of light illuminated at an incident angle of 45° with respect to the multilayer coating film and received at angles of 15°, 25°, and 45° deviated from specular reflection light, and that L*15, L*25, and L*45 each represent a lightness of the multilayer coating film calculated from a spectral reflectance of light illuminated at an incident angle of 45° with respect to the multilayer coating film and received at angles of 15°, 25° and 45° deviated from specular reflection light.

### TECHNICAL FIELD

The present invention relates to a multilayer coating film and a method for forming a multilayer coating film.

### BACKGROUND ART

Recent years have seen demand for sophisticated designs for items such as automobiles.

For example, PTL 1 discloses a coating method for forming a multilayer coating film that has a metallic coating color with dense graininess and metallic feeling, as well as a high degree of chroma and darkness of color. The method includes applying an effect-pigment-containing metallic base paint (A) to the surface of a substrate, and then applying a clear colored paint (B), wherein the metallic base paint (A) has an IV value of 230 or more, and the graininess (HG value) of the formed coating film is 60 or less.

### CITATION LIST

### Patent Literature

PTL 1: JP2005-169385A

### SUMMARY OF INVENTION

### Technical Problem

From a design viewpoint, darkness is preferred in a bluish multilayer coating film formed by laminating a transparent colored coating film formed from a transparent colored paint on a metallic base coating film formed from a metallic base paint. However, if the lightness from highlight to bottom greatly changes and the coating film has excessive darkness, the lightness and chroma of highlight decrease, and the color of the coating film appears dark on the whole. PTL 1 does not focus on maintaining a high degree of lightness and chroma in highlight of a coating film.

An object of the present invention is to provide a multilayer coating film that exhibits excellent darkness and a high degree of lightness and chroma in highlight, and a method for forming the multilayer coating film.

### Solution to Problem

The present invention includes, for example, the embodiments described in the following items.

### Item 1.

A multilayer coating film comprising
a metallic base coating film, and
a transparent colored coating film that contains a blue pigment and that is disposed on the metallic base coating film,
   wherein

the value of hue angle h in an L*C*h color space diagram of the multilayer coating film is within the range of 225° to 300°, and

when X=C*45/L*45 and Y=[(L*15)²+(C*15)²)]^{1/2}+[(L*25)²+(C*25)²)]^{1/2}, X is 2 to 20 and Y is 50 to 250,

provided that C*15, C*25, and C*45 each represent a chroma of the multilayer coating film calculated from a spectral reflectance of light illuminated at an incident angle of 45° with respect to the multilayer coating film and received at angles of 15°, 25°, and 45° deviated from specular reflection light, and that L*15, L*25, and L*45 each represent a lightness of the multilayer coating film calculated from a spectral reflectance of light illuminated at an incident angle of 45° with respect to the multilayer coating film and received at angles of 15°, 25° and 45° deviated from specular reflection light.

### Item 2.

The multilayer coating film according to Item 1, wherein X is 4 to 15 and Y is 100 to 200.

### Item 3.

The multilayer coating film according to Item 1, wherein X is 9 to 12 and Y is 150 to 180.

### Item 4.

The multilayer coating film according to any one of Items 1 to 3, wherein the metallic base coating film contains an aluminum flake pigment, a surface-adjusting agent, and a rheology control agent.

### Item 5.

The multilayer coating film according to any one of Items 1 to 4, wherein the transparent colored coating film contains a resin component, and 0.5 to 10 parts by mass of the blue pigment per 100 parts by mass of resin solids of the transparent colored coating film.

### Item 6.

The multilayer coating film according to any one of Items 1 to 5, further comprising a clear coating film on the transparent colored coating film.

### Item 7.

An object comprising the multilayer coating film of any one of Items 1 to 6.

### Item 8.

A method for forming a multilayer coating film comprising the following steps (1) to (3):

step (1) of applying a metallic base paint to a substrate to form a metallic base coating film,

step (2) of applying a transparent colored paint that contains a blue pigment to the metallic base coating film to form a transparent colored coating film that contains the blue pigment, and

step (3) of separately or concurrently heating the metallic base coating film formed in step (1) and the transparent colored coating film that contains the blue pigment formed in step (2) to cure the coating films,

wherein

the value of hue angle h in an L*C*h color space diagram of the multilayer coating film is within the range of 225° to 300°, and

when X=C*45/L*45 and Y=[(L*15)²+(C*15)²)]^{1/2}+[(L*25)²+(C*25)²)]^{1/2}, X is 2 to 20 and Y is 50 to 250,

provided that C*15, C*25, and C*45 each represent a chroma of the multilayer coating film calculated from a spectral reflectance of light illuminated at an incident angle of 45° with respect to the multilayer coating film and received at angles of 15°, 25°, and 45° deviated from specular reflection light, and that L*15, L*25, and L*45 each represent a lightness of the multilayer coating film calculated from a spectral reflectance of light illuminated at an incident angle of 45° with respect to the multilayer coating film and received at angles of 15°, 25° and 45° deviated from specular reflection light.

### Item 9.

The method for forming a multilayer coating film according to Item 8, wherein the metallic base paint contains water, 0.2 to 6 parts by mass of an aluminum flake pigment on a solids basis per 100 parts by mass of the metallic base paint, a surface-adjusting agent, and a rheology control agent.

### Item 10.

The method for forming a multilayer coating film according to Item 8 or 9, wherein the blue pigment has a haze value of 0 to 50.

### Item 11.

The method for forming a multilayer coating film according to any one of Items 8 to 10, wherein after being cured, the metallic base coating film has a film thickness of 0.02 to 5 μm.

### Advantageous Effects of Invention

The multilayer coating film according to the present invention provides a bluish multilayer coating film that exhibits excellent darkness and a high degree of lightness and chroma in highlight. Such a multilayer coating film enables an object to which the multilayer coating film is applied to have an appearance that is excellent in darkness and is vivid and bright, as well as attractive.

### BRIEF DESCRIPTION OF DRAWINGS

FIG. 1 illustrates the configuration of a coating film and the gloss distribution due to variable angles.

### DESCRIPTION OF EMBODIMENTS

The multilayer coating film according to the present invention includes
a metallic base coating film, and
a transparent colored coating film that contains a blue pigment and that is disposed on the metallic base coating film,
   wherein

the value of hue angle h in an L*C*h color space diagram of the multilayer coating film is within the range of 225° to 300°, and

when X=C*45/L*45 (Equation 1)

and

Y=[(L*15)²+(C*15)²)]^{1/2}+[(L*25)²+(C*25)²)]^{1/2} (Equation 2),

X is 2 to 20 and Y is 50 to 250.

The L*C*h color space refers to a color space created on the basis of the L*a*b*color space, which was standardized in 1976 by the Commission Internationale de l'Eclairage and also adopted in JIS Z 8729.

The multilayer coating film according to the present invention includes bluish multilayer coating films because the value of the hue angle h in the L*C*h color space diagram calculated based on the spectral reflectance of light illuminated at an angle of 45° with respect to the coating film and received at an angle of 45° deviated from specular reflection light is within the range of 225° to 300°. The L*C*h color space was devised from the L*a*b* color space, which was standardized in 1976 by the Commission Internationale de l'Eclairage, and also adopted in JIS Z 8729.

C*15, C*25, and C*45 respectively represent the chroma at an angle of 15°, 25°, and 45° of a multilayer coating film illuminated at an incident angle of 45°.

C*15, C*25, and C*45 are respectively defined as the numerical value of chroma calculated from the spectral reflectance of light illuminated at an angle of 45° with respect to the obtained coating film and received at angles of 15°, 25°, and 45° deviated from specular reflection light, using a multi-angle spectrophotometer (produced by X-Rite Inc., trade name: MA-68II).

L*15, L*25, and L*45 respectively represent the lightness at an angle of 15°, 25° and 45° of a multilayer coating film illuminated at an incident angle of 45°.

L*15, L*25, and L*45 are respectively defined as the numerical value of lightness calculated from the spectral reflectance of light illuminated at an angle of 45° with respect to the obtained coating film and received at angles of 15°, 25°, and 45° deviated from specular reflection light, using a multi-angle spectrophotometer (produced by X-Rite Inc., trade name: MA-68II).

The term “highlight” means observing a multilayer coating film near the specular reflection light. The term “bottom” means observing a multilayer coating film at an angle at which the film is unaffected by the specular reflection light. The term “face” means observing a multilayer coating film at an angle between the highlight and the bottom.

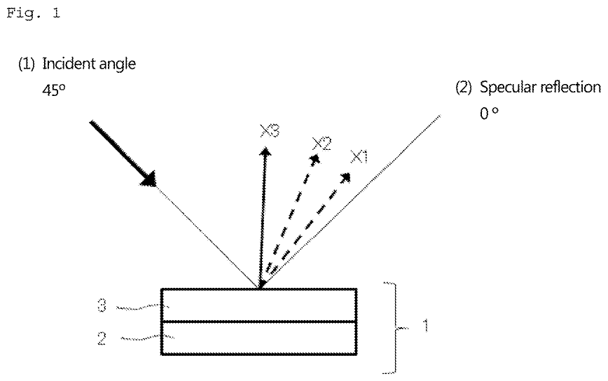

As shown in FIG. 1, in the present application, the spectral reflectance at a receiving angle of 15° (X1), 25° (X2), and 45° (X3) derived from specular reflection light was measured using a multi-angle spectrophotometer (produced by X-Rite Inc., trade name: MA-68II) in order to accurately determine the optical properties of a multilayer coating film 1 from the highlight at an angle of 15° derived from specular reflection light (1) to the face at an angle of 45° derived from specular reflection light (1), from fewer measured reflectances. For lightness, the spectral reflectance measurement values at two angles, i.e., 15° (X1) and 25° (X2) in the highlight, were used. FIG. 1 illustrates the multilayer coating film 1 containing a metallic base coating film 2 and a transparent colored coating film 3 that contains a blue pigment, and that is disposed on the metallic base coating film 2.

X in Equation 1 is an index of darkness expressed with chroma C*45 in the face (45°) and lightness L*45 in the face (45°) as variables. A larger value of X indicates higher darkness.

A value of X of less than 2 is not preferable in terms of design due to a lack of darkness in the multilayer coating film. A value of X of more than 20 is not preferable because the lightness in the face decreases compared with the chroma, and the lightness in the highlight also decreases.

Y in Equation 2 is an index of lightness and chroma of a multilayer coating film in the highlight expressed with chroma C*15 at 15°, chroma C*25 at 25°, lightness L*15 at 15°, and lightness L*25 at 25° as variables. At angles of 15° and 25°, the reflectance changes abruptly in the highlight. Y can be a measure of a combination of lightness and chroma of a multilayer coating film in the highlight perceived by an observer viewing the multilayer coating film.

A value of Y of less than 50 results in poor lightness and chroma in the highlight of a multilayer coating film. A value of Y of more than 250 leads to poor darkness.

When X is 2 to 20 and Y is 50 to 250, a multilayer coating film that exhibits excellent darkness and a high degree of lightness and chroma in highlight is provided.

In an embodiment, X is 4 to 15 and Y is 100 to 200. This configuration results in a multilayer coating film that exhibits better darkness and a higher degree of lightness and chroma in highlight.

In another embodiment, X is 9 to 12 and Y is 150 to 180. This configuration results in a multilayer coating film that exhibits better darkness and a higher degree of lightness and chroma in highlight.

### Configuration of Each Layer of Multilayer Coating Film

The configuration of each layer of the multilayer coating film according to the present invention is described below.

### Metallic Base Coating Film

The metallic base coating film contains an aluminum flake pigment, a surface-adjusting agent, and a rheology control agent.

The metallic base coating film is formed by applying a metallic base paint (A) and preferably drying it. The metallic base coating film has a thickness of preferably about 0.02 to 5 μm, more preferably 0.02 to 4 μm, and still more preferably about 0.02 to 3.5 μm on a dry film basis. A thickness of 0.02 μm or more on a dry film basis leads to sufficient masking of the undercoating, whereas a thickness of 5.0 μm or less on a dry film basis is advantageous in terms of the unlikeliness of defects occurring in coating operation, such as popping and sagging.

The metallic base paint (A) contains water as the main solvent, and also contains an aluminum flake pigment, a surface-adjusting agent, and a rheology control agent.

The aluminum flake pigment is a flaky pigment containing aluminum and is used for hiding an undercoating layer below the metallic base coating film and obtaining a coating film with excellent metallic luster. The aluminum flake pigment includes vapor deposition aluminum flake pigments and aluminum base flake pigments.

The vapor deposition aluminum flake pigment is obtained by vapor-depositing an aluminum film on a base material, removing the base material, and then grinding the vapor deposition aluminum film. Examples of base materials include films.

Examples of commercial products that can be used as a vapor deposition aluminum flake pigment include Metalure series (trade name, produced by Eckart), Hydroshine WS series (trade name, produced by Eckart), Decomet series (trade name, produced by Schlenk), and Metasheen series (trade name, produced by BASF).

The vapor deposition aluminum flake pigment has an average thickness of preferably 0.005 to 1 μm, and more preferably 0.01 to 0.1 μm.

The vapor deposition aluminum flake pigment has an average particle size (D50) of preferably 1 to 50 μm, and more preferably 5 to 20 μm. Such an average particle size is preferable from the standpoint of, for example, storage stability of the vapor deposition aluminum flake pigment in paint, excellent metallic luster of the coating film, and excellent darkness and a high degree of lightness and chroma in highlight of the obtained multilayer coating film.

“Particle size” as used here refers to the median size in a volume-weighted particle size distribution measured by laser diffraction scattering with a Microtrac MT3300 particle size distribution analyzer (trade name, produced by Nikkiso Co., Ltd.).

The aluminum base flake pigment is a flaky pigment that contains aluminum as a base material. The aluminum base flake pigment is preferably one that has been treated so as to prevent or reduce a reaction with water, and particularly preferably one that has been surface-treated with silica, from the standpoint of, for example, storage stability of the aluminum base flake pigment in paint, excellent metallic luster of the coating film, excellent darkness and a high degree of lightness and chroma in highlight of the obtained multilayer coating film.

The aluminum base flake pigment has an average thickness of preferably 0.03 to 2 μm, more preferably, 0.05 to 1 μm, and still more preferably 0.05 to 0.1 μm.

The aluminum base flake pigment has an average particle size (D50) of preferably 1 to 50 μm, and more preferably about 5 to 20 μm. Such an average particle size is preferable from the standpoint of, for example, storage stability of the aluminum base flake pigment in paint, excellent metallic luster of the coating film, excellent darkness and a high degree of lightness and chroma in highlight of the obtained multilayer coating film.

The aluminum flake pigment for use may be either an aluminum base flake pigment or a vapor deposition aluminum flake pigment, or both.

The total content of the aluminum flake pigment in the metallic base paint (A) is preferably 0.2 to 6 parts by mass, more preferably 0.3 to 5 parts by mass, and still more preferably 0.5 to 4.5 parts by mass, on a solids basis, per 100 parts by mass of the metallic base paint, from the standpoint of excellent darkness and a high degree of lightness and chroma in highlight of the obtained multilayer coating film.

Preferably, the total content of the aluminum flake pigment in the metallic base paint (A) is preferably 2 to 97 mass %, more preferably 5 to 65 mass %, and particularly preferably 10 to 60 mass %, on a solids basis, per 100 parts by mass of the total solids contained in the metallic base paint (A), from the standpoint of excellent darkness and a high degree of lightness and chroma in highlight of the obtained multilayer coating film.

In the present specification, “solids” refers to non-volatile matter, which is a residue obtained by removing volatile components such as water and an organic solvent from a sample. The solids content can be calculated by multiplying the mass of the sample by the solids concentration. The solids concentration can be determined by dividing the mass of a residue obtained by drying 3 g of a sample at 105° C. for 3 hours by the mass of the sample before being dried.

The surface-adjusting agent is used to facilitate uniform orientation of the aluminum flake pigment dispersed in water on an object when the metallic base paint (A) is applied to the surface of the object.

The surface-adjusting agent has a contact angle of preferably 8 to 20°, more preferably 9 to 19°, and still more preferably 10 to 18°, with respect to a tin plate degreased beforehand (produced by Paltek Corporation). The contact angle is measured as follows. A liquid that is a mixture of isopropanol, water, and a surface-adjusting agent in a mass ratio of 4.5/95/1 is adjusted to have a viscosity of 150 mPa·s as measured with a Brookfield viscometer at a rotor rotational speed of 60 rpm at a temperature of 20° C., and 10 μL of the liquid is added dropwise to the degreased tin plate. Then, the contact angle with respect to the tin plate is measured 10 seconds after dropping the liquid.

The mass ratio 4.5/95/1, which is the ratio of the isopropanol/water/surface-adjusting agent, corresponds to the component ratio of a dispersion for evaluating the surface-adjusting agent. The viscosity, 150 mPa·s, measured with a Brookfield viscometer at a rotor rotational speed of 60 rpm is a normal value at the time the liquid is applied to the surface of an object. The contact angle, 8 to 20°, with respect to the tin plate represents spread of the liquid under standard coating conditions. A contact angle of 8° or more enables the liquid to be applied to the surface of an object without the liquid spreading too much, and a contact angle of 20° or less enables the liquid to be uniformly applied to the surface of the object without the liquid being repelled too much.

The surface-adjusting agent for use may be a known surface-adjusting agent.

Examples of surface-adjusting agents include silicone-based surface-adjusting agents, acrylic-based surface-adjusting agents, vinyl-based surface-adjusting agents, fluorine-based surface-adjusting agents, and acetylene diol-based surface-adjusting agents. These surface-adjusting agents can be used singly, or in a combination of two or more.

Silicone-based surface-adjusting agents for use include polydimethylsiloxane, and modified silicone obtained by modifying polydimethylsiloxane. Examples of modified silicone include polyether-modified silicone, acrylic-modified silicone, and polyester-modified silicone.

Examples of commercial products of surface-adjusting agents include BYK series (produced by BYK-Chemie), Tego series (produced by Evonik), Glanol series and Polyflow series (produced by Kyoeisha Chemical Co., Ltd.), Disparlon series (produced by Kusumoto Chemicals, Ltd.), and Surfynol (registered trademark) series (produced by Evonik Industries).

The content of the surface-adjusting agent in the metallic base paint (A) is 4 to 400 parts by mass, more preferably 5 to 100 parts by mass, and still more preferably 8 to 60 parts by mass, on a solids basis, per 100 parts by mass of the solids of the aluminum flake pigment, from the standpoint of obtaining a multilayer coating film that exhibits a high degree of lightness and chroma in highlight.

The content of the surface-adjusting agent is 0.01 to 20 parts by mass, more preferably 0.02 to 10 parts by mass, and still more preferably 0.05 to 5 parts by mass, per 100 parts by mass of the total solids of the metallic base paint (A) from the standpoint of obtaining a multilayer coating film that exhibits a high degree of lightness and chroma in highlight.

The rheology control agent for use may be a known rheology control agent. Examples include silica-based fine powder, mineral-based rheology control agents, barium sulfate fine powder, polyamide-based rheology control agents, organic-resin-fine-particle rheology control agents, diurea-based rheology control agents, urethane association-type rheology control agents, polyacrylic acid-based rheology control agents, which are acrylic swelling-type, and cellulose-based rheology control agents. Of these, particularly from the standpoint of obtaining a coating film with excellent metallic luster, a mineral-based rheology control agent, a polyacrylic acid-based rheology control agent, and a cellulose-based rheology control agent are preferable for use; a cellulose-based rheology control agent is particularly preferable. These rheology control agents can be used singly, or in a combination of two or more.

Examples of mineral-based rheology control agents include swelling laminar silicate that has a 2:1 crystalline structure. Specific examples include smectite clay minerals, such as natural or synthetic montmorillonite, saponite, hectorite, stevensite, beidellite, nontronite, bentonite, and laponite; swelling mica clay minerals, such as Na-type tetrasilicic fluorine mica, Li-type tetrasilicic fluorine mica, Na salt-type fluorine taeniolite, and Li-type fluorine taeniolite; vermiculite; substituted products or derivatives thereof; and mixtures thereof.

Examples of polyacrylic acid-based rheology control agents include sodium polyacrylate and polyacrylic acid-(meth)acrylic acid ester copolymers.

Examples of commercial products of polyacrylic acid-based rheology control agents include Primal ASE-60, Primal TT615, and Primal RM5 (trade names, produced by The Dow Chemical Company); and SN Thickener 613, SN Thickener 618, SN Thickener 630, SN Thickener 634, and SN Thickener 636 (trade names, produced by San Nopco Limited). The acid value of the solids in the polyacrylic acid-based rheology control agent for use may be 30 to 300 mg KOH/g, and preferably 80 to 280 mg KOH/g.

Examples of cellulose-based rheology control agents include carboxymethylcellulose, methylcellulose, hydroxyethylcellulose, hydroxyethylmethylcellulose, hydroxypropylmethylcellulose, methylcellulose, and cellulose nanofibers. Of these, cellulose nanofibers are particularly preferable for use from the standpoint of obtaining a coating film with excellent metallic luster.

The cellulose nanofibers may also be referred to as “cellulose nanofibrils,” “fibrillated cellulose,” or “nanocellulose crystals.”

The cellulose nanofibers have a number average fiber diameter of preferably 2 to 500 nm, more preferably 2 to 250 nm, and still more preferably 2 to 150 nm, from the standpoint of obtaining a coating film with excellent metallic luster. The cellulose nanofibers also have a number average fiber length of preferably 0.1 to 20 μm, more preferably 0.1 to 15 μm, and still more preferably 0.1 to 10 μm. The aspect ratio determined by dividing the number average fiber length by the number average fiber diameter is preferably 50 to 10000, more preferably 50 to 5000, and still more preferably 50 to 1000.

The number average fiber diameter and number average fiber length are measured and calculated from, for example, an image obtained by subjecting a sample (cellulose nanofibers diluted with water) to a dispersion treatment, casting the sample on a grid coated with a carbon film that has been subjected to hydrophilic treatment, and observing the sample with a transmission electron microscope (TEM).

The cellulose nanofibers for use may be those obtained by defibrating a cellulose material and stabilizing it in water. The cellulose material as used here refers to cellulose-main materials in various forms. Specific examples include pulp (e.g., grass plant-derived pulp, such as wood pulp, jute, Manila hemp, and kenaf); natural cellulose, such as cellulose produced by microorganisms; regenerated cellulose obtained by dissolving cellulose in a copper ammonia solution or a solvent such as a morpholine derivative, and subjecting the dissolved cellulose to spinning; and fine cellulose obtained by subjecting the cellulose material to mechanical treatment, such as hydrolysis, alkali hydrolysis, enzymatic decomposition, blasting treatment, or vibration ball milling, to depolymerize the cellulose.

Cellulose nanofibers for use may be anionically modified cellulose nanofibers. Examples of anionically modified cellulose nanofibers include carboxylated cellulose nanofibers, carboxymethylated cellulose nanofibers, and phosphate-group-containing cellulose nanofibers. The anionically modified cellulose nanofibers can be obtained, for example, by incorporating functional groups such as carboxyl groups, carboxymethyl groups, and phosphate groups into a cellulose material by a known method, washing the obtained modified cellulose to prepare a dispersion of the modified cellulose, and defibrating this dispersion. The carboxylated cellulose is also referred to as “oxidized cellulose.”

The oxidized cellulose can be obtained, for example, by oxidizing the cellulose material in water using an oxidizing agent in the presence of a compound selected from the group consisting of an N-oxyl compound, a bromide, an iodide, and a mixture thereof.

Examples of commercial products of cellulose nanofibers include Rheocrysta (registered trademark) produced by DKS Co. Ltd.

The content of the rheology control agent in the metallic base paint (A) is preferably 0.1 to 97 parts by mass, more preferably 0.5 to 80 parts by mass, and still more preferably 1 to 60 parts by mass, on a solids basis, per 100 parts by mass of the total solids of the metallic base paint (A) from the standpoint of obtaining a multilayer coating film that exhibits a high degree of lightness and chroma in highlight.

The content of the cellulose-based rheology control agent in the metallic base paint (A) is preferably 2 to 97 parts by mass, particularly preferably 5 to 80 parts by mass, and still more preferably 10 to 60 parts by mass, on a solids basis, per 100 parts by mass of the total solids of the metallic base paint (A).

When a rheology control agent other than the cellulose-based rheology control agent is used, the content of the rheology control agent is preferably 1 to 200 parts by mass, and more preferably 50 to 150 parts by mass, on a solids basis, per 100 parts by mass of the solids of the cellulose-based rheology control agent.

The metallic base paint (A) may further optionally contain, for example, an organic solvent, a pigment other than the aluminum flake pigment, a pigment dispersant, a pigment derivative, an antisettling agent, a phosphate-group-containing resin, a base resin and/or a dispersion resin, an antifoaming agent, and an ultraviolet absorber.

Pigments other than the aluminum flake pigment include a blue pigment, a white pigment, and an interference pigment.

Blue pigments include a phthalocyanine pigment, a threne pigment, and an indigoid pigment.

Phthalocyanine pigments include copper phthalocyanine, which is also referred to as “phthalocyanine blue” (e.g., α-form, β-form, and ε-form). The threne pigment includes indanthrone blue. The indigoid pigment includes indigo, thioindigo, and derivatives thereof.

From the standpoint of forming a multilayer coating film that exhibits excellent darkness and a high degree of lightness and chroma in highlight, the blue pigment is preferably at least one member selected from the group consisting of a phthalocyanine pigment and a threne pigment.

A white pigment, an interference pigment, or a combination thereof can be used for forming a multilayer coating film that exhibits a high degree of lightness and chroma in highlight.

White pigments include titanium oxide and zinc oxide. White pigments can be used singly, or in a combination of two or more.

Interference pigments are effect pigments obtained by coating the surface of a transparent or translucent flaky base material, such as natural mica, synthetic mica, glass, iron oxide, aluminum oxide, or various other metal oxides, with a metal oxide having a refractive index different from that of the base material. Interference pigments may be used singly, or in a combination of two or more.

Natural mica is a flaky base material obtained by pulverizing mica from ore. Synthetic mica is synthesized by heating an industrial material, such as SiO₂, MgO, Al₂O₃, K₂SiF₆, or Na₂SiF₆, to melt the material at a high temperature of about 1500° C., and cooling the melt for crystallization. When compared with natural mica, synthetic mica contains a smaller amount of impurities and has a more uniform size and thickness. Specific examples of synthetic mica base materials include fluorophlogopite (KMg₃AlSi₃O₁₀F₂), potassium tetrasilicon mica (KMg_{2.5}AlSi₄O₁₀F₂), sodium tetrasilicon mica (NaMg_{2.5}AlSi₄O₁₀F₂), Na taeniolite (NaMg₂LiSi₄O₁₀F₂), and LiNa taeniolite (LiMg₂LiSi₄O₁₀F₂).

Examples of metal oxides include titanium oxide and iron oxide. Interference pigments can develop various different interference colors depending on the difference in the thickness of the metal oxide.

Specific examples of interference pigments include the following metal oxide-coated mica pigments, metal oxide-coated alumina flake pigments, metal oxide-coated glass flake pigments, and metal oxide-coated silica flake pigments.

Metal oxide-coated mica pigments are pigments obtained by coating the surface of a natural mica or synthetic mica base material with a metal oxide.

Metal oxide-coated alumina flake pigments are pigments obtained by coating the surface of an alumina flake base material with a metal oxide. Alumina flakes refer to flaky (thin) aluminum oxides, which are clear and colorless. Alumina flakes do not necessarily consist of only aluminum oxide, and may contain other metal oxides.

Metal oxide-coated glass flake pigments are pigments obtained by coating the surface of a flaky glass base material with a metal oxide. The metal oxide-coated glass flake pigments have a smooth base material surface, which causes intense light reflection.

Metal oxide-coated silica flake pigments are pigments obtained by coating flaky silica, which is a base material having a smooth surface and a uniform thickness, with a metal oxide.

Of the interference pigments, those obtained by coating the surface of a base material, such as natural mica, synthetic mica, silicon dioxide, or aluminum oxide, with a metal oxide, such as titanium oxide or iron oxide, are preferable from the standpoint of increasing the lightness and chroma in highlight of the coating film. Such pigments are called “pearl pigments” because they have a pearlescent texture and transparency. Examples of pearl pigments include white pearl pigments that are obtained by coating the surface of a natural or synthetic mica base material with titanium oxide and that exhibit white color due to reflection of multiple reflection light; interference pearl pigments that are obtained by coating the surface of a natural or synthetic mica base material with titanium oxide and that develop a color due to interference of multiple reflection light; and color pearl pigments that are obtained by coating the surface of a natural or synthetic mica base material with iron oxide.

The interference pigment for use preferably has an average particle size of 5 to 30 μm, and particularly preferably 7 to 20 μm from the standpoint of excellent darkness and a high degree of chroma and lightness in highlight of the obtained multilayer coating film.

The interference pigment for use preferably has a thickness of 0.05 to 1 μm, and particularly preferably 0.1 to 0.8 μm from the standpoint of excellent darkness and a high degree of chroma and lightness in highlight of the obtained multilayer coating film. The thickness as used here is defined as the average value determined by measuring the minor axis of interference pigment particles using image processing software while observing the cross-sectional surface of a coating film that contains an interference pigment with an optical microscope, and calculating the average value of the measured minor axis of 100 or more particles.

The content of the interference pigment in the metallic base paint (A) is preferably 0.1 to 10 parts by mass, and more preferably 0.5 to 8 parts by mass, on a solids basis, per 100 parts by mass of the metallic base paint (A) from the standpoint of excellent darkness and a high degree of chroma and lightness in highlight of the obtained multilayer coating film.

The pigment derivative preferably has a phthalocyanine skeleton. Examples of commercial products of pigment derivatives include Solsperse 5000, Solsperse 12000 (trade name, produced by Lubrizol Corporation), and EFKA 6745 (trade name, produced by EFKA.

The metallic base paint (A) preferably contains a phosphate-group-containing resin from the standpoint of metallic luster and water resistance of the obtained coating film.

The phosphate-group-containing resin can be produced, for example, by copolymerizing a phosphate-group-containing polymerizable unsaturated monomer and another polymerizable unsaturated monomer by a known method, such as solution polymerization. Examples of phosphate-group-containing polymerizable unsaturated monomers include acid phosphooxyethyl (meth)acrylate, acid phosphooxypropyl (meth)acrylate, and a reaction product of glycidyl (meth)acrylate with alkyl phosphoric acid. These phosphate-group-containing polymerizable unsaturated monomers may be used singly, or in a combination of two or more.

The metallic base paint (A) may contain a base resin and/or a dispersion resin from the standpoint of a high degree of lightness and chroma in highlight of the obtaining the obtained coating film. However, even if the metallic base paint (A) substantially contains no such resins, the effects of the present invention can be brought about.

Examples of base resins include acrylic resins, polyester resins, alkyd resins, and urethane resins.

Examples of dispersion resins for use include existing dispersion resins, such as acrylic resin-based dispersion resins, epoxy resin-based dispersion resins, polycarboxylic acid resin-based dispersion resins, and polyester-based dispersion resins.

The content of paint solids in the metallic base paint (A) is preferably 1 to 20%, and more preferably 2 to 15%.

A Transparent-Colored Coating Film that Contains a Blue Pigment

The transparent-colored coating film that contains a blue pigment (or simply “transparent colored coating film” below) contains a resin, a curing agent, and a color pigment. The content of the color pigment is preferably 0.1 to 10 parts by mass, per 100 parts by mass of the resin solids of the transparent colored coating film.

The transparent colored coating film is formed by applying a transparent colored paint (B), and preferably drying the applied transparent colored paint (B). The transparent colored coating film may be a monolayer or composed of two or more layers. The total thickness of the transparent colored coating film on a dry film basis is preferably about 10 to 100 μm, and more preferably about 15 to 80 μm. A total thickness on a dry film basis of 10 μm or more leads to excellent color development of the coating film. A total thickness on a dry film basis of 100 μm or less is advantageous in terms of the unlikeliness of defects occurring in coating operation, such as popping and sagging.

The transparent colored paint (B) contains a resin, a curing agent, and a color pigment. The resin includes a base resin and a dispersion resin.

The transparent colored paint (B) contains a blue pigment as a color pigment. The blue pigment includes a phthalocyanine pigment, a threne pigment, and an indigoid pigment.

The phthalocyanine pigment includes copper phthalocyanine (also referred to as “phthalocyanine blue”; e.g., α-form, β-form, and ε-form). The threne pigment includes indanthrone blue. The indigoid pigment includes indigo, thioindigo, and derivatives thereof.

From the standpoint of forming a multilayer coating film that exhibits excellent darkness and a high degree of lightness and chroma in highlight, the blue pigment is preferably at least one member selected from the group consisting of a phthalocyanine pigment and a threne pigment.

The blue pigment has a haze value of 0 to 50, more preferably 5 to 40, and still more preferably 8 to 30. Due to the haze value within the range of 0 to 50, a bluish multilayer coating film that exhibits excellent darkness and a high degree of lightness and chroma in highlight is obtained.

The haze value of the blue pigment is defined as follows. A blue pigment is added to an aqueous paint (WBC-713T, trade name, produced by Kansai Paint Co., Ltd., a pigment-free, colorless transparent aqueous base paint for vehicles) such that the amount of the blue pigment is 10 parts by mass per 100 parts by mass of the resin in the aqueous paint, and the mixture is well stirred. The obtained paint is applied to an OHP film for PPC laser (produced by Kiso Chemical Co., Ltd.) by using a doctor blade (produced by Taiyu Kizai K.K.), and allowed to stand at room temperature for 3 minutes, followed by preheating at 80° C. for 3 minutes. The coating film is then baked and cured at 140° C. for 30 minutes, thereby obtaining a transparent blue coating film with a film thickness of 15 μm. This coating film is measured with a COH-300A turbidimeter (trade name, produced by Nippon Denshoku Industries Co., Ltd.) for diffuse light transmittance (DF) and parallel light transmittance (PT), and a haze value is calculated from the diffuse light transmittance and parallel light transmittance by using the following formula (3).

Haze Value (%)=100*DF/(DF+PT) (3)

In an embodiment, the transparent colored paint (B) is a transparent colored base paint (B1).

The base resin contained in the transparent colored base paint (B1) includes base resins such as acrylic resins, polyester resins, alkyd resins, urethane resins, and epoxy resins, which all contain a crosslinkable functional group such as carboxyl or hydroxyl.

The dispersion resin is used for ease of mixing the pigment in a paint.

The dispersion resin to be contained in the transparent colored base paint (B1) can be a known dispersion resin without any limitations. In particular, the dispersion resin is preferably an AB block polymer.

The AB block polymer can be any AB block polymer and can be a known AB block polymer having a functional site adsorbed to a pigment (e.g., an amino group and a quaternary ammonium salt group). In the present invention, the AB block polymer is preferably a block polymer that contains an A block that contains a structural unit derived from an amino-group-containing polymerizable unsaturated monomer and a structural unit derived from a (meth)acrylic acid alkyl ester, and a B block that contains a structural unit derived from a polyoxyalkylene chain-containing polymerizable unsaturated monomer and a structural unit derived from (meth)acrylic acid alkyl ester. As long as the AB block polymer contains these blocks, the AB block polymer may contain a triblock.

Examples of amino-group-containing polymerizable unsaturated monomers for use include tertiary amino-group-containing polymerizable unsaturated monomers, including N,N-dialkylaminoalkyl (meth)acrylate, such as N,N-dimethylaminoethyl (meth)acrylate, N,N-diethylaminoethyl (meth)acrylate, N,N-dimethylaminopropyl (meth)acrylate, N,N-di-t-butylaminoethyl (meth)acrylate, and N,N-dimethylamino butyl (meth)acrylate; and N,N-dialkylaminoalkyl (meth)acrylamide, such as N,N-dimethylaminoethyl (meth)acrylamide, N,N-diethylaminoethyl (meth)acrylamide, and N,N-dimethylaminopropyl (meth)acrylamide.

Examples of (meth)acrylic acid alkyl ester include C1 to C24 linear or cyclic alkyl (meth)acrylate monomers, such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, 2-ethylhexyl (meth)acrylate, n-octyl (meth)acrylate, lauryl (meth)acrylate, stearyl (meth)acrylate, cyclohexyl (meth)acrylate, isobornyl (meth)acrylate, and tridecyl (meth)acrylate.

The polyoxyalkylene-chain-containing polymerizable unsaturated monomer contains a polyoxyalkylene chain and a polymerizable unsaturated group in one monomer. Examples of polyoxyalkylene chains include a polyoxyethylene chain, a polyoxypropylene chain, and a block chain of a polyoxyethylene and a polyoxypropylene. The polyoxyalkylene chain preferably has a molecular weight within the range of 200 to 3000, and particularly preferably 300 to 2500. Specific examples include tetraethylene glycol (meth)acrylate, methoxy tetraethylene glycol (meth)acrylate, ethoxy tetraethylene glycol (meth)acrylate, n-butoxy tetraethylene glycol (meth)acrylate, tetrapropylene glycol (meth)acrylate, methoxy tetrapyroprene glycol (meth)acrylate, ethoxy tetrapropylene glycol (meth)acrylate, n-butoxy tetrapropylene glycol (meth)acrylate, polyethylene glycol (meth)acrylate, polypropylene glycol (meth)acrylate, methoxy polyethylene glycol (meth)acrylate, and ethoxy polyethylene glycol (meth)acrylate.

Each block polymer for use may be an optionally selected other polymerizable unsaturated monomer. Examples of other such polymerizable unsaturated monomers include 2-hydroxyethyl (meth)acrylate, hydroxypropyl (meth)acrylate, hydroxybutyl (meth)acrylate, and hydroxy-containing polymerizable unsaturated monomers, such as compounds obtained by subjecting these hydroxy alkyl (meth)acrylate monomers with a lactone such as ε-caprolactone to ring-opening polymerization; carboxy-containing polymerizable unsaturated monomers, such as methacrylic acid and acrylic acid; aromatic vinyl compounds, such as styrene, α-methyl styrene, vinyl toluene, and benzyl (meth)acrylate; and (meth)acrylonitrile and vinyl acetate. These polymerizable unsaturated monomers can be used singly, or in a combination of two or more.

It is preferred that the AB block polymer contain an amino-group-containing polymerizable unsaturated monomer in an amount of 5 to 50 mass %, and preferably 10 to 40 mass %, based on the total amount of monomers that constitute an A block (solids content), and contain a polyoxyalkylene-chain-containing polymerizable unsaturated monomer in an amount of 10 to 70 mass %, and preferably 20 to 45 mass %, based on the total amount of monomers that constitute a B block (solids content). It is also preferred from the standpoint of increasing dispersibility that the ratio (mass ratio) of the total amount of monomers that constitute an A block to the total amount of monomers that constitute a B block be within the range of 10/90 to 60/40, and preferably 20/80 to 50/50.

The AB block polymer can be produced by a known technique and can be obtained particularly by an addition-fragmentation chain transfer polymerization method using an addition-fragmentation chain transfer agent. Specifically, a block polymer can be produced by subjecting the monomer components that constitute a block to addition-fragmentation chain transfer polymerization in the presence of an addition-fragmentation chain transfer agent. The addition-fragmentation chain transfer polymerization can be performed, for example, by solution polymerization in an organic solvent or emulsion polymerization in water. In polymerization, a known radical polymerization initiator can be optionally used in combination with the addition-fragmentation chain transfer agent.

The addition-fragmentation chain transfer agent for use is preferably, for example, 2,4-diphenyl-4-methyl-1-pentene (also called “α-methyl styrene dimer” or abbreviated as “MSD”). MSD is preferably used in the first polymerization.

It is preferred that the AB block polymer obtained as described above has a weight average molecular weight within the range of 2000 to 100000, and preferably 3000 to 20000; and an amine value within the range of 50 mg KOH/g or less, and preferably 3 to 30 mg KOH/g.

The curing agent to be contained in the transparent colored base paint (B1) includes crosslinking agents, such as amino resins (e.g., melamine resin and urea resin) and blocked or unblocked polyisocyanate compounds. In particular, a thermosetting aqueous paint that contains at least one member selected from the group consisting of a hydroxy-containing polyester resin and a hydroxy-containing acrylic resin as a base resin, and a melamine resin as a curing agent is preferably used as a transparent colored base paint (B1).

The proportion of the base resin and the curing agent for use is as follows: the proportion of the base resin is preferably 50 to 90 mass %, and more preferably 65 to 80 mass % on a solids mass basis, and the proportion of the curing agent is preferably 50 to 10 mass %, and more preferably 35 to 20 mass % on a solids mass basis.

The color pigment to be contained in the transparent-colored base paint (B1) can be used singly or in a combination of two or more.

The transparent colored base paint (B1) contains a blue pigment as a color pigment. Examples of blue pigments include phthalocyanine pigments, threne pigments, and indigoid pigments.

Examples of phthalocyanine pigments include copper phthalocyanine (also called “phthalocyanine blue”; e.g., α-form, β-form, and ε-form). Examples of threne pigments include indanthrone blue. Examples of indigoid pigments include indigo, thioindigo, and derivatives thereof.

From the standpoint of forming a multilayer coating film that exhibits excellent darkness and a high degree of lightness and chroma in highlight, the blue pigment is preferably at least one member selected from the group consisting of a phthalocyanine pigment and a threne pigment.

The blue pigment content in the transparent colored base paint (B1) is not particularly limited; it is preferred that the blue pigment content in the transparent colored base paint (B1) be 0.5 to 10 parts by mass, and preferably 0.7 to 10 parts by mass, per 100 parts by mass of the resin solids in the transparent colored base paint (B1).

The transparent colored base paint (B1) may further contain, as a color pigment other than the blue pigment, at least one color pigment selected from the group consisting of a red pigment, an orange pigment, a yellow pigment, and a green pigment.

The total amount of the color pigment present in the transparent colored base paint (B1) is not particularly limited, and is preferably 0.5 to 10 parts by mass per 100 parts by mass of the resin solids contained in the transparent-colored base paint (B1).

The transparent colored base paint (B1) may also contain an effect pigment in addition to the blue pigment. Examples of effect pigments include aluminum flake pigments, white pigments, and interference pigments. The aluminum flake pigments, white pigments, and interference pigments are as explained above for the metallic base paint (A).

The solids content of the transparent colored base paint (B1) may be 60 mass % or less, and the solids content at the time of application may be 10 to 50 mass %.

The transparent colored base paint (B1) may further optionally contain commonly used additives for paints, such as an extender pigment, a curing catalyst, an ultraviolet absorber, a light stabilizer, a rheology control agent, an antioxidant, a surface-adjusting agent, an antifoaming agent, and wax.

In another embodiment, the transparent colored paint (B) is a transparent colored clear paint (B2) (which may be simply referred to as a “colored clear paint (B2)” below).

Examples of the base resin contained in the transparent colored clear paint (B2) include base resins, such as acrylic resins, polyester resins, alkyd resins, and urethane resins, which contain a crosslinkable functional group such as a carboxyl group, a hydroxyl group, a silanol group, an alkoxysilyl group, or an epoxy group.

The dispersion resin to be contained in the transparent colored clear paint (B2) may be a known dispersion resin without any limitations. In particular, the dispersion resin is preferably an AB block polymer.

The AB block polymer for use may be the same as those explained for the transparent colored base paint (B1).

Examples of the curing agent contained in the transparent colored clear paint (B2) include crosslinking agents, such amino resins (e.g., melamine resin and urea resin), blocked or unblocked polyisocyanate compounds, epoxy compounds, carboxy-containing compounds, acid anhydrides, and alkoxysilyl group-containing compounds.

The proportion of the base resin and the curing agent is as follows: the proportion of the base resin is preferably 50 to 90 mass %, and more preferably 65 to 80 mass %, on a solids basis, and the proportion of the curing agent is preferably 50 to 10 mass %, and more preferably 35 to 20 mass %, on a solids basis.

The color pigment to be contained in the transparent colored clear paint (B2) may be one color pigment, or a combination of two or more color pigments.

The transparent colored clear paint (B2) contains a blue pigment as a color pigment. Examples of blue pigments include phthalocyanine pigments, threne pigments, and indigoid pigments. From the standpoint of forming a multilayer coating film that exhibits excellent darkness and a high degree of lightness and chroma in highlight, the blue pigment is preferably at least one member selected from the group consisting of a phthalocyanine pigment and a threne pigment.

The blue pigment content in the transparent colored clear paint (B2) is not particularly limited, and it is preferred that the blue pigment content in the transparent colored clear paint (B2) be 0.1 to 5 parts by mass, preferably 0.1 to 4 parts by mass, more preferably 0.1 to 3 parts by mass, and particularly preferably 0.8 to 3 parts by mass, per 100 parts by mass of the resin solids in the transparent colored clear paint (B2).

The transparent colored clear paint (B2) may further contain as a color pigment at least one color pigment selected from the group consisting of a red pigment, an orange pigment, a yellow pigment, and a green pigment.

The total amount of the color pigment present in the transparent colored clear paint (B2) is not particularly limited, and is preferably 0.1 to 5 parts by mass per 100 parts by mass of the resin solids contained in the transparent colored base paint (B2).

The transparent colored clear paint (B2) may also contain an effect pigment in addition to the blue pigment. Examples of effect pigments include aluminum flake pigments, white pigments, and interference pigments. The aluminum flake pigments, white pigments, and interference pigments are as explained above for the metallic base paint (A).

The solids content of the transparent colored clear paint (B2) may be 70 mass % or less, and the solids content at the time of application may be 10 to 60 mass %.

The transparent colored clear paint (B2) may further optionally contain commonly used additives for paints, such as a curing catalyst, an ultraviolet absorber, a light stabilizer, a rheology control agent, an antioxidant, a surface-adjusting agent, an antifoaming agent, and wax.

Each of the transparent colored coating films obtained by applying the transparent colored paint (B) preferably contains 90 to 99.5 parts by mass of the resin component and 0.5 to 10 parts by mass of the color pigment, and more preferably 97 to 99.5 parts by mass of the resin component, and 0.5 to 3 parts by mass of the color pigment, per 100 parts by mass of the solids of the transparent colored coating film. Such a configuration makes it easier to form the multilayer coating film of the present invention.

The value of X in Equation 1 and the value of Y in Equation 2 of the multilayer coating film of the present invention can be suitably set by a person skilled in the art by selecting the components and their content in the metallic base paint (A) and the transparent colored paint (B). This makes it easier to produce a multilayer coating film that exhibits excellent darkness and a high degree of lightness and chroma in highlight.

In addition to the metallic base coating film and transparent colored coating film, the multilayer coating film according to the present invention may further contain at least one of the following: an intermediate coating film, a base coating film, and a clear coating film. The intermediate coating film, base coating film, and clear coating film may each be a monolayer, or composed of two or more layers. The configuration of the intermediate coating film, base coating film, and clear coating film is described in detail in the Method for Forming a Multilayer Coating Film section below.

In the multilayer coating film according to the present invention, at least one of the following may also contain a blue pigment in addition to the transparent colored coating film: the metallic base coating film, the intermediate coating film, the base coating film, and the clear coating film. The blue pigment may be identical to or different from the blue pigment contained in the transparent colored coating film. Examples of such blue pigments include phthalocyanine pigments, threne pigments, and indigoid pigments. Examples of multilayer coating films in which the metallic base coating film, the intermediate coating film, the base coating film, or the clear coating film, or a combination of these films, contains a blue pigment include the following.

In an embodiment, the configuration of the multilayer coating film of the present invention can be, for example, the following configurations. The layers laminated on an object are listed from left to right in the order in which they are laminated. The coating film that corresponds to the transparent colored coating film that contains a blue pigment is accompanied by the parenthesized phrase “a transparent colored coating film that contains a blue pigment.”

1. The configuration of a metallic base coating film and a transparent colored clear coating film.
1-1. A metallic base coating film, and a transparent colored clear coating film (a transparent colored coating film that contains a blue pigment)
1-2. A blue-pigment-containing metallic base coating film, and a transparent colored clear coating film (a transparent colored coating film that contains a blue pigment)
2. The configuration of a clear coating film, a metallic base coating film, and a transparent colored clear coating film.
2-1. A clear coating film, a metallic base coating film, and a transparent colored clear coating film (a transparent colored coating film that contains a blue pigment)
2-2. A clear coating film, a blue-pigment-containing metallic base coating film, and a transparent colored clear coating film (a transparent colored coating film that contains a blue pigment)
2-3. A blue-pigment-containing clear coating film, a metallic base coating film, and a transparent colored clear coating film (a transparent colored coating film that contains a blue pigment)
2-4. A blue-pigment-containing clear coating film, a blue-pigment-containing metallic base coating film, and a transparent colored clear coating film (a transparent colored coating film that contains a blue pigment)
3. The configuration of a clear coating film, a metallic base coating film, a clear coating film, and a clear coating film (at least one of the two consecutive clear coating films being a transparent colored clear coating film)
3-1 to 3-4. A laminate in which a clear coating film is further stacked on the transparent colored clear coating film of each multilayer coating film of 2-1 to 2-4 above
3-5 to 3-8. A laminate in which a transparent colored clear coating film (a transparent colored coating film that contains a blue pigment) is further stacked on the transparent colored clear coating film of each multilayer coating film of 2-1 to 2-4 above
3-9. A clear coating film, a metallic base coating film, a clear coating film, and a transparent colored clear coating film (a transparent colored coating film that contains a blue pigment)
3-10. A clear coating film, a blue-pigment-containing metallic base coating film, a clear coating film, and a transparent colored clear coating film (a transparent colored coating film that contains a blue pigment)
3-11. A blue-pigment-containing clear coating film, a metallic base coating film, a clear coating film, and a transparent colored clear coating film (a transparent colored coating film that contains a blue pigment)
3-12. A blue-pigment-containing clear coating film, a blue-pigment-containing metallic base coating film, a clear coating film, and a transparent colored clear coating film (a transparent colored coating film that contains a blue pigment)
4. The configuration of an intermediate coating film, a metallic base coating film, and a transparent colored clear coating film
4-1. An intermediate coating film, a metallic base coating film, and a transparent colored clear coating film (a transparent colored coating film that contains a blue pigment)
4-2. An intermediate coating film, a blue-pigment-containing metallic base coating film, and a transparent colored clear coating film (a transparent colored coating film that contains a blue pigment)
4-3. A blue-pigment-containing intermediate coating film, a metallic base coating film, and a transparent colored clear coating film (a transparent colored coating film that contains a blue pigment)
4-4. A blue-pigment-containing intermediate coating film, a blue-pigment-containing metallic base coating film, and a transparent colored clear coating film (a transparent colored coating film that contains a blue pigment)
5. The configuration of an intermediate coating film, a base coating film, a metallic base coating film, and a transparent colored clear coating film
5-1. An intermediate coating film, a base coating film, a metallic base coating film, and a transparent colored clear coating film (a transparent colored coating film that contains a blue pigment)
5-2. An intermediate coating film, a blue-pigment-containing base coating film, a metallic base coating film, and a transparent colored clear coating film (a transparent colored coating film that contains a blue pigment)
5-3. An intermediate coating film, a base coating film, a blue-pigment-containing metallic base coating film, and a transparent colored clear coating film (a transparent colored coating film that contains a blue pigment)
5-4. An intermediate coating film, a blue-pigment-containing base coating film, a blue-pigment-containing metallic base coating film, and a transparent colored clear coating film (a transparent colored coating film that contains a blue pigment)
5-5. A blue-pigment-containing intermediate coating film, a base coating film, a metallic base coating film, and a transparent colored clear coating film (a transparent colored coating film that contains a blue pigment)
5-6. A blue-pigment-containing intermediate coating film, a blue-pigment-containing base coating film, a metallic base coating film, and a transparent colored clear coating film (a transparent colored coating film that contains a blue pigment)
5-7. A blue-pigment-containing intermediate coating film, a base coating film, a blue-pigment-containing metallic base coating film, and a transparent colored clear coating film (a transparent colored coating film that contains a blue pigment)
5-8. A blue-pigment-containing intermediate coating film, a blue-pigment-containing base coating film, a blue-pigment-containing metallic base coating film, and a transparent colored clear coating film (a transparent colored coating film that contains a blue pigment)
6. The configuration of an intermediate coating film, a base coating film, a metallic base coating film, a clear coating film, and a clear coating film (at least one of the two consecutive clear coating films being a transparent colored clear coating film)
6-1 to 6-8. A laminate in which a clear coating film is further stacked on the transparent colored clear coating film of each multilayer coating film of 5-1 to 5-8 above
6-9 to 6-16. A laminate in which a transparent colored clear coating film (a transparent colored coating film that contains a blue pigment) is further stacked on the transparent colored clear coating film of each multilayer coating film of 5-1 to 5-8 above
6-17. An intermediate coating film, a base coating film, a metallic base coating film, a clear coating film, and a transparent colored clear coating film (a transparent colored coating film that contains a blue pigment)
6-18. An intermediate coating film, a blue-pigment-containing base coating film, a metallic base coating film, a clear coating film, and a transparent colored clear coating film (a transparent colored coating film that contains a blue pigment)
6-19. An intermediate coating film, a base coating film, a blue-pigment-containing metallic base coating film, a clear coating film, and a transparent colored clear coating film (a transparent colored coating film that contains a blue pigment)
6-20. An intermediate coating film, a blue-pigment-containing base coating film, a blue-pigment-containing metallic base coating film, a clear coating film, and a transparent colored clear coating film (a transparent colored coating film that contains a blue pigment)
6-21. A blue-pigment-containing intermediate coating film, a base coating film, a metallic base coating film, a clear coating film, and a transparent colored clear coating film (a transparent colored coating film that contains a blue pigment)
6-22. A blue-pigment-containing intermediate coating film, a blue-pigment-containing base coating film, a metallic base coating film, a clear coating film, and a transparent colored clear coating film (a transparent colored coating film that contains a blue pigment)
6-23. A blue-pigment-containing intermediate coating film, a base coating film, a blue-pigment-containing metallic base coating film, a clear coating film, and a transparent colored clear coating film (a transparent colored coating film that contains a blue pigment)
6-24. A blue-pigment-containing intermediate coating film, a blue-pigment-containing base coating film, a blue-pigment-containing metallic base coating film, a clear coating film, and a transparent colored clear coating film (a transparent colored coating film that contains a blue pigment)
7. The configuration of an intermediate coating film, a metallic base coating film, a clear coating film, a base coating film, and a clear coating film (the clear coating film, base coating film, or clear coating film, or a combination of these films, being a transparent colored coating film)
7-1. An intermediate coating film, a metallic base coating film, a clear coating film, a base coating film, and a transparent colored clear coating film (a transparent colored coating film that contains a blue pigment)
7-2. An intermediate coating film, a metallic base coating film, a clear coating film, a transparent colored base coating film (a transparent colored coating film that contains a blue pigment), and a clear coating film
7-3. An intermediate coating film, a metallic base coating film, a clear coating film, a transparent colored base coating film (a transparent colored coating film that contains a blue pigment), and a transparent colored clear coating film (a transparent colored coating film that contains a blue pigment)
7-4. An intermediate coating film, a metallic base coating film, a transparent colored clear coating film (a transparent colored coating film that contains a blue pigment), a base coating film, and a clear coating film
7-5. An intermediate coating film, a metallic base coating film, a transparent colored clear coating film (a transparent colored coating film that contains a blue pigment), a transparent colored base coating film (a transparent colored coating film that contains a blue pigment), and a clear coating film
7-6. An intermediate coating film, a metallic base coating film, a transparent colored clear coating film (a transparent colored coating film that contains a blue pigment), a transparent colored base coating film (a transparent colored coating film that contains a blue pigment), and a transparent colored clear coating film (a transparent colored coating film that contains a blue pigment)
7-7. An intermediate coating film, a blue-pigment-containing metallic base coating film, a clear coating film, a base coating film, and a transparent colored clear coating film (a transparent colored coating film that contains a blue pigment)
7-8. An intermediate coating film, a blue-pigment-containing metallic base coating film, a clear coating film, a transparent colored base coating film (a transparent colored coating film that contains a blue pigment), and a clear coating film
7-9. An intermediate coating film, a blue-pigment-containing metallic base coating film, a clear coating film, a transparent colored base coating film (a transparent colored coating film that contains a blue pigment), and a transparent colored clear coating film (a transparent colored coating film that contains a blue pigment)
7-10. An intermediate coating film, a blue-pigment-containing metallic base coating film, a transparent colored clear coating film (a transparent colored coating film that contains a blue pigment), a base coating film, and a clear coating film
7-11. An intermediate coating film, a blue-pigment-containing metallic base coating film, a transparent colored clear coating film (a transparent colored coating film that contains a blue pigment), a transparent colored base coating film (a transparent colored coating film that contains a blue pigment), and a clear coating film
7-12. An intermediate coating film, a blue-pigment-containing metallic base coating film, a transparent colored clear coating film (a transparent colored coating film that contains a blue pigment), and a transparent colored clear coating film (a transparent colored coating film that contains a blue pigment)
7-13. A blue-pigment-containing intermediate coating film, a metallic base coating film, a clear coating film, a base coating film, and a transparent colored clear coating film (a transparent colored coating film that contains a blue pigment)
7-14. A blue-pigment-containing intermediate coating film, a metallic base coating film, a clear coating film, a transparent colored base coating film (a transparent-colored coating film that contains a blue pigment), and a clear coating film
7-15. A blue-pigment-containing intermediate coating film, a metallic base coating film, a clear coating film, a transparent colored base coating film (a transparent colored coating film that contains a blue pigment), and a transparent colored clear coating film (a transparent colored coating film that contains a blue pigment)
7-16. A blue-pigment-containing intermediate coating film, a metallic base coating film, a transparent colored clear coating film (a transparent colored coating film that contains a blue pigment), a base coating film, and a clear coating film
7-17. A blue-pigment-containing intermediate coating film, a metallic base coating film, a transparent colored clear coating film (a transparent colored coating film that contains a blue pigment), a transparent colored base coating film (a transparent colored coating film that contains a blue pigment), and a clear coating film
7-18. A blue-pigment-containing intermediate coating film, a metallic base coating film, a transparent colored clear coating film (a transparent colored coating film that contains a blue pigment), a transparent colored base coating film (a transparent colored coating film that contains a blue pigment), and a transparent colored clear coating film (a transparent colored coating film that contains a blue pigment)
7-19. A blue-pigment-containing intermediate coating film, a blue-pigment-containing metallic base coating film, a clear coating film, a base coating film, and a transparent colored clear coating film (a transparent colored coating film that contains a blue pigment)
7-20. A blue-pigment-containing intermediate coating film, a blue-pigment-containing metallic base coating film, a clear coating film, a transparent colored base coating film (a transparent colored coating film that contains a blue pigment), and a clear coating film
7-21. A blue-pigment-containing intermediate coating film, a blue-pigment-containing metallic base coating film, a clear coating film, a transparent colored base coating film (a transparent colored coating film that contains a blue pigment), and a transparent colored clear coating film (a transparent colored coating film that contains a blue pigment)
7-22. A blue-pigment-containing intermediate coating film, a blue-pigment-containing metallic base coating film, a transparent colored clear coating film (a transparent colored coating film that contains a blue pigment), a base coating film, and a clear coating film
7-23. A blue-pigment-containing intermediate coating film, a blue-pigment-containing metallic base coating film, a transparent colored clear coating film (a transparent colored coating film that contains a blue pigment), a transparent colored base coating film (a transparent colored coating film that contains a blue pigment), and a clear coating film
7-24. A blue-pigment-containing intermediate coating film, a blue-pigment-containing metallic base coating film, a transparent colored clear coating film (a transparent colored coating film that contains a blue pigment), a transparent colored base coating film (a transparent colored coating film that contains a blue pigment), and a transparent colored clear coating film (a transparent colored coating film that contains a blue pigment)
8. The configuration of an intermediate coating film, a base coating film, a metallic base coating film, a clear coating film, a base coating film, and a clear coating film (the clear coating film, base coating film, or clear coating film, or a combination of these films, being a transparent colored coating film)
8-1. An intermediate coating film, a base coating film, a metallic base coating film, a clear coating film, a base coating film, and a transparent colored clear coating film (a transparent colored coating film that contains a blue pigment)
8-2. An intermediate coating film, a blue-pigment-containing base coating film, a metallic base coating film, a clear coating film, a base coating film, and a transparent colored clear coating film (a transparent colored coating film that contains a blue pigment)
8-3. An intermediate coating film, a base coating film, a metallic base coating film, a clear coating film, a transparent colored base coating film (a transparent colored coating film that contains a blue pigment), and a clear coating film
8-4. An intermediate coating film, a blue-pigment-containing base coating film, a metallic base coating film, a clear coating film, a transparent colored base coating film (a transparent colored coating film that contains a blue pigment), and a clear coating film
8-5. An intermediate coating film, a base coating film, a metallic base coating film, a clear coating film, a transparent colored base coating film (a transparent colored coating film that contains a blue pigment), and a transparent colored clear coating film (a transparent colored coating film that contains a blue pigment)
8-6. An intermediate coating film, a blue-pigment-containing base coating film, a metallic base coating film, a clear coating film, a transparent colored base coating film (a transparent colored coating film that contains a blue pigment), and a transparent colored clear coating film (a transparent colored coating film that contains a blue pigment)
8-7. An intermediate coating film, a base coating film, a metallic base coating film, a transparent colored clear coating film (a transparent colored coating film that contains a blue pigment), a base coating film, and a clear coating film
8-8. An intermediate coating film, a blue-pigment-containing base coating film, a metallic base coating film, a transparent colored clear coating film (a transparent colored coating film that contains a blue pigment), a base coating film, and a clear coating film
8-9. An intermediate coating film, a base coating film, a metallic base coating film, a transparent colored clear coating film (a transparent colored coating film that contains a blue pigment), a transparent colored base coating film (a transparent colored coating film that contains a blue pigment), and a clear coating film
8-10. An intermediate coating film, a blue-pigment-containing base coating film, a metallic base coating film, a transparent colored clear coating film (a transparent colored coating film that contains a blue pigment), a transparent colored base coating film (a transparent colored coating film that contains a blue pigment), and a clear coating film
8-11. An intermediate coating film, a base coating film, a metallic base coating film, a transparent colored clear coating film (a transparent colored coating film that contains a blue pigment), a transparent colored base coating film (a transparent colored coating film that contains a blue pigment), and a transparent colored clear coating film (a transparent colored coating film that contains a blue pigment)
8-12. An intermediate coating film, a blue-pigment-containing base coating film, a metallic base coating film, a transparent colored clear coating film (a transparent colored coating film that contains a blue pigment), a transparent colored base coating film (a transparent colored coating film that contains a blue pigment), and a transparent colored clear coating film (a transparent colored coating film that contains a blue pigment)
8-13. An intermediate coating film, a base coating film, a blue-pigment-containing metallic base coating film, a clear coating film, a base coating film, and a transparent colored clear coating film (a transparent colored coating film that contains a blue pigment)
8-14. An intermediate coating film, a blue-pigment-containing base coating film, a blue-pigment-containing metallic base coating film, a clear coating film, a base coating film, and a transparent colored clear coating film (a transparent colored coating film that contains a blue pigment)
8-15. An intermediate coating film, a base coating film, a blue-pigment-containing metallic base coating film, a clear coating film, a transparent colored base coating film (a transparent colored coating film that contains a blue pigment), and a clear coating film
8-16. An intermediate coating film, a blue-pigment-containing base coating film, a blue-pigment-containing metallic base coating film, a clear coating film, a transparent colored base coating film (a transparent colored coating film that contains a blue pigment), and a clear coating film
8-17. An intermediate coating film, a base coating film, a blue-pigment-containing metallic base coating film, a clear coating film, a transparent colored base coating film (a transparent colored coating film that contains a blue pigment), and a transparent colored clear coating film (a transparent colored coating film that contains a blue pigment)
8-18. An intermediate coating film, a blue-pigment-containing base coating film, a blue-pigment-containing metallic base coating film, a clear coating film, a transparent-colored base coating film (a transparent colored coating film that contains a blue pigment), and a transparent colored clear coating film (a transparent colored coating film that contains a blue pigment)
8-19. An intermediate coating film, a base coating film, a blue-pigment-containing metallic base coating film, a transparent colored clear coating film (a transparent colored coating film that contains a blue pigment), a base coating film, and a clear coating film
8-20. An intermediate coating film, a blue-pigment-containing base coating film, a blue-pigment-containing metallic base coating film, a transparent colored clear coating film (a transparent colored coating film that contains a blue pigment), a base coating film, and a clear coating film
8-21. An intermediate coating film, a base coating film, a blue-pigment-containing metallic base coating film, a transparent colored clear coating film (a transparent colored coating film that contains a blue pigment), a transparent colored base coating film (a transparent colored coating film that contains a blue pigment), and a clear coating film
8-22. An intermediate coating film, a blue-pigment-containing base coating film, a blue-pigment-containing metallic base coating film, a transparent colored clear coating film (a transparent colored coating film that contains a blue pigment), a transparent colored base coating film (a transparent colored coating film that contains a blue pigment), and a clear coating film
8-23. An intermediate coating film, a base coating film, a blue-pigment-containing metallic base coating film, a transparent colored clear coating film (a transparent colored coating film that contains a blue pigment), and a transparent colored clear coating film (a transparent colored coating film that contains a blue pigment)
8-24. An intermediate coating film, a blue-pigment-containing base coating film, a blue-pigment-containing metallic base coating film, a transparent colored clear coating film (a transparent colored coating film that contains a blue pigment), and a transparent colored clear coating film (a transparent colored coating film that contains a blue pigment)
8-25. A blue-pigment-containing intermediate coating film, a base coating film, a metallic base coating film, a clear coating film, a base coating film, and a transparent colored clear coating film (a transparent colored coating film that contains a blue pigment)
8-26. A blue-pigment-containing intermediate coating film, a blue-pigment-containing base coating film, a metallic base coating film, a clear coating film, a base coating film, and a transparent colored clear coating film (a transparent colored coating film that contains a blue pigment)
8-27. A blue-pigment-containing intermediate coating film, a base coating film, a metallic base coating film, a clear coating film, a transparent colored base coating film (a transparent colored coating film that contains a blue pigment), and a clear coating film
8-28. A blue-pigment-containing intermediate coating film, a blue-pigment-containing base coating film, a metallic base coating film, a clear coating film, a transparent colored base coating film (a transparent colored coating film that contains a blue pigment), and a clear coating film
8-29. A blue-pigment-containing intermediate coating film, a base coating film, a metallic base coating film, a clear coating film, a transparent colored base coating film (a transparent colored coating film that contains a blue pigment), and a transparent colored clear coating film (a transparent colored coating film that contains a blue pigment)
8-30. A blue-pigment-containing intermediate coating film, a blue-pigment-containing base coating film, a metallic base coating film, a clear coating film, a transparent colored base coating film (a transparent colored coating film that contains a blue pigment), and a transparent colored clear coating film (a transparent colored coating film that contains a blue pigment)
8-31. A blue-pigment-containing intermediate coating film, a base coating film, a metallic base coating film, a transparent colored clear coating film (a transparent colored coating film that contains a blue pigment), a base coating film, and a clear coating film
8-32. A blue-pigment-containing intermediate coating film, a blue-pigment-containing base coating film, a metallic base coating film, a transparent colored clear coating film (a transparent colored coating film that contains a blue pigment), a base coating film, and a clear coating film
8-33. A blue-pigment-containing intermediate coating film, a base coating film, a metallic base coating film, a transparent colored clear coating film (a transparent colored coating film that contains a blue pigment), a transparent colored base coating film (a transparent colored coating film that contains a blue pigment), and a clear coating film
8-34. A blue-pigment-containing intermediate coating film, a blue-pigment-containing base coating film, a metallic base coating film, a transparent colored clear coating film (a transparent colored coating film that contains a blue pigment), a transparent colored base coating film (a transparent colored coating film that contains a blue pigment), and a clear coating film
8-35. A blue-pigment-containing intermediate coating film, a base coating film, a metallic base coating film, a transparent colored clear coating film (a transparent colored coating film that contains a blue pigment), a transparent colored base coating film (a transparent colored coating film that contains a blue pigment), and a transparent colored clear coating film (a transparent colored coating film that contains a blue pigment)
8-36. A blue-pigment-containing intermediate coating film, a blue-pigment-containing base coating film, a metallic base coating film, a transparent colored clear coating film (a transparent colored coating film that contains a blue pigment), a transparent colored base coating film (a transparent colored coating film that contains a blue pigment), and a transparent colored clear coating film (a transparent colored coating film that contains a blue pigment)
8-37. A blue-pigment-containing intermediate coating film, a base coating film, a blue-pigment-containing metallic base coating film, a clear coating film, a base coating film, and a transparent colored clear coating film (a transparent colored coating film that contains a blue pigment)
8-38. A blue-pigment-containing intermediate coating film, a blue-pigment-containing base coating film, a blue-pigment-containing metallic base coating film, a clear coating film, a base coating film, and a transparent colored clear coating film (a transparent colored coating film that contains a blue pigment)
8-39. A blue-pigment-containing intermediate coating film, a base coating film, a blue-pigment-containing metallic base coating film, a clear coating film, a transparent colored base coating film (a transparent colored coating film that contains a blue pigment), and a clear coating film
8-40. A blue-pigment-containing intermediate coating film, a blue-pigment-containing base coating film, a blue-pigment-containing metallic base coating film, a clear coating film, a transparent colored base coating film (a transparent colored coating film that contains a blue pigment), and a clear coating film
8-41. A blue-pigment-containing intermediate coating film, a base coating film, a blue-pigment-containing metallic base coating film, a clear coating film, a transparent colored base coating film (a transparent colored coating film that contains a blue pigment), and a transparent colored clear coating film (a transparent colored coating film that contains a blue pigment)
8-42. A blue-pigment-containing intermediate coating film, a blue-pigment-containing base coating film, a blue-pigment-containing metallic base coating film, a clear coating film, a transparent colored base coating film (a transparent colored coating film that contains a blue pigment), and a transparent colored clear coating film (a transparent colored coating film that contains a blue pigment)
8-43. A blue-pigment-containing intermediate coating film, a base coating film, a blue-pigment-containing metallic base coating film, a transparent colored clear coating film (a transparent colored coating film that contains a blue pigment), a base coating film, and a clear coating film
8-44. A blue-pigment-containing intermediate coating film, a blue-pigment-containing base coating film, a blue-pigment-containing metallic base coating film, a transparent colored clear coating film (a transparent colored coating film that contains a blue pigment), a base coating film, and a clear coating film
8-45. A blue-pigment-containing intermediate coating film, a base coating film, a blue-pigment-containing metallic base coating film, a transparent colored clear coating film (a transparent colored coating film that contains a blue pigment), a transparent colored base coating film (a transparent colored coating film that contains a blue pigment), and a clear coating film
8-46. A blue-pigment-containing intermediate coating film, a blue-pigment-containing base coating film, a blue-pigment-containing metallic base coating film, a transparent colored clear coating film (a transparent colored coating film that contains a blue pigment), a transparent colored base coating film (a transparent colored coating film that contains a blue pigment), and a clear coating film
8-47. A blue-pigment-containing intermediate coating film, a base coating film, a blue-pigment-containing metallic base coating film, a transparent colored clear coating film (a transparent colored coating film that contains a blue pigment), a transparent colored base coating film (a transparent colored coating film that contains a blue pigment), and a transparent colored clear coating film (a transparent colored coating film that contains a blue pigment)
8-48. A blue-pigment-containing intermediate coating film, a blue-pigment-containing base coating film, a blue-pigment-containing metallic base coating film, a transparent colored clear coating film (a transparent colored coating film that contains a blue pigment), a transparent colored base coating film (a transparent colored coating film that contains a blue pigment), and a transparent colored clear coating film (a transparent colored coating film that contains a blue pigment)
9. The configuration of an intermediate coating film, a metallic base coating film, a clear coating film, a base coating film, a clear coating film, and a clear coating film (the clear coating film, base coating film, clear coating film, or clear coating film, or a combination of these films, being a transparent colored coating film)
9-1 to 9-24. A laminate in which a clear coating film is further stacked on the clear coating film or transparent colored clear coating film of each of 7-1 to 7-24
9-25 to 9-48. A laminate in which a transparent colored clear coating film (a transparent colored coating film that contains a blue pigment) is further stacked on the clear coating film or transparent colored clear coating film of each of 7-1 to 7-24
9-49. An intermediate coating film, a metallic base coating film, a clear coating film, a base coating film, a clear coating film, and a transparent colored clear coating film (a transparent colored coating film that contains a blue pigment)
9-50. An intermediate coating film, a blue-pigment-containing metallic base coating film, a clear coating film, a base coating film, a clear coating film, and a transparent colored clear coating film (a transparent colored coating film that contains a blue pigment)
9-51. A blue-pigment-containing intermediate coating film, a metallic base coating film, a clear coating film, a base coating film, a clear coating film, and a transparent colored clear coating film (a transparent colored coating film that contains a blue pigment)
9-52. A blue-pigment-containing intermediate coating film, a blue-pigment-containing metallic base coating film, a clear coating film, a base coating film, a clear coating film, and a transparent colored clear coating film (a transparent colored coating film that contains a blue pigment)
10. The configuration of an intermediate coating film, a base coating film, a metallic base coating film, a clear coating film, a base coating film, a clear coating film, and a clear coating film (the clear coating film, base coating film, clear coating film, or clear coating film, or a combination of these films, being a transparent colored coating film)
10-1 to 10-48. A laminate in which a clear coating film is further stacked on the clear coating film or transparent colored clear coating film of each of 8-1 to 8-48
10-49 to 10-96. A laminate in which a transparent colored clear coating film (a transparent colored coating film that contains a blue pigment) is further stacked on the clear coating film or transparent colored clear coating film of each of 8-1 to 8-48
10-97. An intermediate coating film, a base coating film, a metallic base coating film, a clear coating film, a base coating film, a clear coating film, and a transparent colored clear coating film (a transparent colored coating film that contains a blue pigment)
10-98. A blue-pigment-containing intermediate coating film, a base coating film, a metallic base coating film, a clear coating film, a base coating film, a clear coating film, and a transparent colored clear coating film (a transparent colored coating film that contains a blue pigment)
10-99. An intermediate coating film, a blue-pigment-containing base coating film, a metallic base coating film, a clear coating film, a base coating film, a clear coating film, and a transparent colored clear coating film (a transparent colored coating film that contains a blue pigment)
10-100. An intermediate coating film, a base coating film, a blue-pigment-containing metallic base coating film, a clear coating film, a base coating film, a clear coating film, and a transparent colored clear coating film (a transparent colored coating film that contains a blue pigment)
10-101. A blue-pigment-containing intermediate coating film, a blue-pigment-containing base coating film, a metallic base coating film, a clear coating film, a base coating film, a clear coating film, and a transparent colored clear coating film (a transparent colored coating film that contains a blue pigment)
10-102. An intermediate coating film, a blue-pigment-containing base coating film, a blue-pigment-containing metallic base coating film, a clear coating film, a base coating film, a clear coating film, and a transparent colored clear coating film (a transparent colored coating film that contains a blue pigment)
10-103. A blue-pigment-containing intermediate coating film, a base coating film, a blue-pigment-containing metallic base coating film, a clear coating film, a base coating film, a clear coating film, and a transparent colored clear coating film (a transparent colored coating film that contains a blue pigment)
10-104. A blue-pigment-containing intermediate coating film, a blue-pigment-containing base coating film, a blue-pigment-containing metallic base coating film, a clear coating film, a base coating film, a clear coating film, and a transparent colored clear coating film (a transparent colored coating film that contains a blue pigment)

In a preferable embodiment, the configuration of the multilayer coating film according to the present invention can be, for example, the following configuration. The layers laminated on an object are listed from left to right in the order in which they are laminated. The transparent colored coating film indicates a transparent colored base coating film or a transparent colored clear coating film. The clear coating film or colored clear coating film (the uppermost layer) may be a monolayer or composed of two or more layers.

1. An intermediate coating film, a metallic base coating film, a clear coating film, a transparent colored coating film, a clear coating film
2. An intermediate coating film, a base coating film, a metallic base coating film, a clear coating film, a transparent colored coating film, a clear coating film
3. An intermediate coating film, a metallic base coating film, a colored clear coating film, a transparent colored coating film, a colored clear coating film
4. An intermediate coating film, a base coating film, a metallic base coating film, a colored clear coating film, a transparent colored coating film, a colored clear coating film
5. An intermediate coating film, a metallic base coating film, a colored clear coating film
6. An intermediate coating film, a base coating film, a metallic base coating film, a colored clear coating film

The multilayer coating film in this embodiment according to the present invention can be formed by stacking a metallic base coating film, a transparent colored coating film, and optional other coating films (an intermediate coating film, a base coating film, a clear coating film).

The total optical density of the blue pigment in the blue-pigment-containing coating film is preferably 5 to 400, more preferably 13 to 300, and still more preferably 35 to 280.

“Optical density” as used here refers to the value determined by multiplying the pigment concentration (parts by mass) by the film thickness (μm) of a coating film.

The pigment concentration refers to the amount of a pigment indicated in parts by mass per 100 parts by mass of the total resin solids in a paint.

When there are two or more blue coating films, the optical density of the blue pigment in each coating film is summed. In this case, the film thickness of a coating film free of a blue pigment sandwiched by the two or more blue coating layers is not included.

### A Method for Forming a Multilayer Coating Film

The process for forming the multilayer coating film according to the present invention includes, for example, the following known processes. The films formed on an object are listed from left to right in the order in which they are formed.

Process I: An intermediate paint (C), baking or preheating, a metallic base paint (A), a clear paint (E), baking, a transparent colored paint (B), a clear paint (E), baking
Process II: An intermediate paint (C), baking or preheating, a base paint (D), a metallic base paint (A), a clear paint (E), baking, a transparent colored paint (B), a clear paint (E), baking
Process III: An intermediate paint (C), baking or preheating, a metallic base paint (A), a colored clear paint (E), baking, a transparent colored paint (B), a transparent colored clear paint (B2), baking
Process IV: An intermediate paint (C), baking or preheating, a base paint (D), a metallic base paint (A), a transparent colored clear paint (B2), baking, a transparent colored paint (B), a transparent colored clear paint (B2), baking
Process V: An intermediate paint (C), baking or preheating, a metallic base paint (A), a transparent colored clear coating film (B2), baking
Process VI: An intermediate paint (C), baking or preheating, a base paint (D), a metallic base paint (A), a transparent colored clear paint (B2), baking

The temperature for baking is preferably within the range of 70 to 180° C., and particularly preferably 80 to 170° C. The time period for baking is preferably within the range of 10 to 60 minutes, more preferably 15 to 40 minutes, and particularly preferably 20 to 30 minutes.

The temperature for preheating is preferably within the range of 50 to 100° C., and particularly preferably 70 to 80° C. The time period for preheating is preferably within the range of 1 to 5 minutes, and particularly preferably 2 to 3 minutes.

Process I includes the steps of applying the intermediate paint (C) to an object to form an intermediate coating film, curing the intermediate coating film by heating, applying the metallic base paint (A) to the cured intermediate coating film to form a metallic base coating film, applying the clear paint (E) to the metallic base coating film to form a clear coating film, heating the uncured metallic base coating film and the uncured clear coating film to cure these two coating films simultaneously, applying the transparent colored paint (B) to the cured clear coating film to form a transparent colored coating film, applying the clear paint (E) to the transparent colored coating film to form a clear coating film, and heating the uncured transparent colored coating film and the uncured clear coating film to cure these two coating films simultaneously.

Process II includes the steps of applying the intermediate paint (C) to an object to form an intermediate coating film, curing the intermediate coating film by heating, applying the base paint (D) to the cured intermediate coating film to form a base coating film, applying the metallic base paint (A) to the base coating film to form a metallic base coating film, applying the clear paint to the metallic base coating film to form a clear coating film, heating the uncured base coating film, the uncured metallic base coating film, and the uncured clear coating film to cure these three coating films simultaneously, applying the transparent colored paint (B) to the cured clear coating film to form a transparent colored coating film, applying the clear paint (E) to the transparent colored coating film to form a clear coating film, and heating the uncured transparent colored coating film and the uncured clear coating film to cure these two coating films simultaneously.

Process III includes the steps of applying the intermediate paint (C) to an object to form an intermediate coating film, curing the intermediate coating film by heating, applying the metallic base paint (A) to the cured intermediate coating film to form a metallic base coating film, applying the clear paint (E) to the metallic base coating film to form a clear coating film, heating the uncured metallic base coating film and the uncured clear coating film to cure these two coating films simultaneously, applying the transparent colored paint (B) to the cured clear coating film to form a transparent colored coating film, applying the transparent colored clear paint (B2) to the transparent colored coating film to form a colored clear coating film, and heating the uncured transparent colored coating film and the uncured colored clear coating film to cure these two coating films simultaneously.

Process IV includes the steps of applying the intermediate paint (C) to an object to form an intermediate coating film, heating the intermediate coating film to cure the intermediate coating film, applying the base paint (D) to the cured intermediate coating film to form a base coating film, applying the metallic base paint (A) to the base coating film to form a metallic base coating film, applying the transparent colored clear paint (B2) to the metallic base coating film to form a colored clear coating film, heating the uncured base coating film, the uncured metallic base coating film, and the uncured colored clear coating film to simultaneously cure these three coating films, applying the transparent colored coating film (B) to the cured transparent colored clear paint (B2) to form a transparent colored coating film, applying the transparent colored clear paint (B2) to the transparent colored coating film to form a transparent colored coating film, heating the uncured colored clear coating film, and heating the uncured transparent colored coating film and the uncured clear coating film to simultaneously cure these two coating films.

Process V includes the steps of applying the intermediate paint (C) to an object to form an intermediate coating film, curing the intermediate coating film by heating, applying the metallic base paint (A) to the cured intermediate coating film to form a metallic base coating film, applying the transparent colored clear paint (B2) to the metallic base coating film to form a transparent colored coating film, and heating the uncured metallic base coating film and the uncured transparent colored coating film to cure these two coating films simultaneously.

Process VI includes the steps of applying the intermediate paint (C) to an object to form an intermediate coating film, heating the intermediate coating film to cure the coating film, applying the base paint (D) to the cured intermediate coating film to form a base coating film, applying the metallic base paint (A) to the cured intermediate coating film to form a metallic base coating film, applying the transparent colored clear paint (B2) to the metallic base coating film to form a transparent colored coating film, and heating the uncured base coating film, the uncured metallic base coating film, and the uncured transparent colored coating film to simultaneously cure these three coating films.

Examples of the object to which the multilayer coating film of the present invention is applied include exterior panel parts of vehicle bodies, such as passenger cars, trucks, motorcycles, and buses; vehicle components; and exterior panel parts of household electric appliances, such as mobile phones and audio equipment. Of these, exterior panel parts of vehicle bodies and vehicle components are preferable.

The material of the object is not particularly limited. Examples of the material include metallic materials, such as iron, aluminum, brass, copper, tin, stainless steel, galvanized steel, and steel plated with zinc alloys (e.g., Zn—Al, Zn—Ni, Zn—Fe); plastic materials, such as various types of fiber-reinforced plastics (FRP), polyethylene resins, polypropylene resins, acrylonitrile-butadiene-styrene (ABS) resins, polyamide resins, acrylic resins, vinylidene chloride resins, polycarbonate resins, polyurethane resins, epoxy resins, and like resins; inorganic materials, such as glass, cement, and concrete; wood; and textile materials, such as paper and cloth. Of these materials, metallic materials and plastic materials are preferable.

The object to which the multilayer coating film is applied also includes exterior panel parts of vehicle bodies, vehicle components, household electric appliances, and metal substrates thereof, such as steel plates whose metal surfaces are subjected to a surface treatment, such as phosphate treatment, chromate treatment, or composite oxide treatment.

The object may or may not be surface-treated, and one or more coating films may be further formed on the object. For example, the object as a base material may optionally be surface-treated, and an undercoating film may be formed on the object; an intermediate coating film may be further formed on the undercoating film. For example, when the object is a vehicle body, the undercoating film and the intermediate coating film can be formed by using known undercoat and intermediate paints commonly used in coating vehicle bodies.

Examples of undercoat paints for forming an undercoating film include electrodeposition paints, and preferably cationic electrodeposition paints. Examples of intermediate paints for forming an intermediate coating film include paints prepared by using a base resin, such as an acrylic resin, polyester resin, alkyd resin, urethane resin, or epoxy resin that contains a crosslinkable functional group (e.g., a carboxyl or hydroxyl group); an amino resin, such as melamine resin or urea resin; and a crosslinking agent, such as a blocked or unblocked polyisocyanate compound, together with a pigment, a thickener, and other optional components.

In the present specification, the phrase “applying the metallic base paint (A) to an object” includes not only the case in which the metallic base paint (A) is directly applied to the object, but also the case in which the metallic base paint (A) is applied after the object is surface-treated and/or one or more additional layers, such as an undercoating film and/or an intermediate coating film, are formed on the object.

For example, as shown in Processes I to VI, the method for forming a multilayer coating film according to an embodiment of the present invention includes the step of applying the intermediate paint (C) to an object to form an intermediate coating film. The intermediate paint (C) in Processes I to III contains a hydrophilic organic solvent as a medium, and the intermediate paint (C) in Processes IV to VI contains water as a medium.

The intermediate paint (C) is preferably a thermosetting paint that is commonly used in the art and that contains a base resin, a crosslinking agent, and a medium containing water and/or a hydrophilic organic solvent.

The base resin and the crosslinking agent for use may be known compounds commonly used in the art. Examples of base resins include acrylic resins, polyester resins, epoxy resins, and polyurethane resins. Examples of crosslinking agents include amino resins, polyisocyanate compounds, and blocked polyisocyanate compounds. Examples of hydrophilic organic solvents for use include methanol, ethanol, n-propyl alcohol, isopropyl alcohol, and ethylene glycol.

The intermediate paint (C) may suitably contain an ultraviolet absorber, an antifoaming agent, a thickener, a rust inhibitor, a surface-adjusting agent, and a pigment in addition to the above components, if necessary.

Examples of pigments include color pigments, extender pigments, and effect pigments. These pigments may be used singly, or in a combination of two or more.

Examples of color pigments include titanium oxide, zinc oxide, carbon black, molybdenum red, azo pigments, phthalocyanine pigments, threne pigments, indigoid pigments, quinacridone pigments, isoindoline pigments, perylene pigments, dioxazine pigments, and diketopyrrolopyrrole pigments. When the intermediate paint (C) contains a blue pigment as a color pigment, examples of the blue pigment include phthalocyanine pigments, threne pigments, and indigoid pigments.

Examples of extender pigments include clay, kaolin, barium sulfate, barium carbonate, calcium carbonate, talc, silica, and alumina white. Of these, barium sulfate and/or talc is preferable for use. In particular, to obtain a multilayer coating film with an appearance with excellent smoothness, it is preferable to use barium sulfate with an average primary particle size of 1 μm or less, and particularly preferably 0.01 to 0.8 μm, as an extender pigment.

Examples of effect pigments include aluminum (including vapor-deposited aluminum), copper, zinc, brass, nickel, aluminum oxide, mica, titanium oxide- or iron oxide-coated aluminum oxide, titanium oxide- or iron oxide-coated mica, glass flakes, and holographic pigments. These effect pigments can be used singly, or in a combination of two or more. Examples of aluminum flake pigments include non-leafing aluminum pigments and leafing aluminum pigments; any of these pigments can be used.

When the intermediate paint (C) contains one or more pigments, the total content of the pigments is typically within the range of 1 to 500 parts by mass, preferably 3 to 400 parts by mass, and more preferably 5 to 300 parts by mass, per 100 parts by mass of the total resin solids in the intermediate paint (C). In particular, it is preferred that the intermediate paint (C) contain a color pigment and/or an extender pigment, and that the total content of the color pigment and the extender pigment be typically within the range of 1 to 500 parts by mass, preferably 3 to 400 parts by mass, and particularly preferably 5 to 300 parts by mass, per 100 parts by mass of the total resin solids in the intermediate paint (C).

When the intermediate paint (C) contains a color pigment described above, the content of the color pigment may be typically within the range of 1 to 300 parts by mass, preferably 3 to 250 parts by mass, and more preferably 5 to 200 parts by mass, per 100 parts by mass of the total resin solids in the intermediate paint (C). The color pigment for use includes a blue pigment.

When the intermediate paint (C) contains an extender pigment described above, the content of the extender pigment may be typically within the range of 1 to 300 parts by mass, preferably 5 to 250 parts by mass, and more preferably 10 to 200 parts by mass, per 100 parts by mass of the total resin solids in the intermediate paint (C).

When the intermediate paint (C) contains an effect pigment described above, the content of the effect pigment may be typically within the range of 0.1 to 50 parts by mass, preferably 0.2 to 30 parts by mass, and more preferably 0.3 to 20 parts by mass, per 100 parts by mass of the total resin solids in the intermediate paint (C).

Coating an article with the intermediate paint (C) of the above configuration improves the surface smoothness, impact resistance, and chipping resistance of the coated article.

The method for applying the intermediate paint (C) for use may be a typical coating method commonly used in the art. Examples of coating methods include those using a brush or a coater. Of these, a coating method using a coater is preferable. The coater is preferably an air-spray coater, an airless spray coater, and a rotary-atomization electrostatic coater, such as a paint cassette coater; and particularly preferably a rotary-atomization electrostatic coater.

The intermediate coating film is preferably a dried coating film obtained by applying the intermediate paint (C) and curing the intermediate paint (C) with heating, from the standpoint of preventing the intermediate coating film and a base coating film to form a mixed layer. In this case, the heating temperature is preferably within the range of 110 to 180° C., and particularly preferably 120 to 160° C. The heat treatment time is preferably within the range of 10 to 60 minutes, and particularly preferably to 40 minutes.

The thickness of the cured film of the intermediate paint (C) after heat treatment under the above conditions is preferably within the range of 10 to 50 μm, and particularly preferably 15 to 40 μm, from the standpoint of excellent darkness and a high degree of lightness and chroma in highlight of the obtained multilayer coating film.

The film thickness having hiding power of color of the intermediate paint (C) is preferably 40 μm or less, more preferably 35 μm or less, and still more preferably 30 μm or less, from the standpoint of, for example, the color stability of the multilayer coating film to be obtained. In the present specification, the “film thickness having hiding power of color” is the value determined in the following manner. The monochrome checkered hiding power test paper specified in 4.1.2 of JIS K5600-4-1 is attached to a steel plate. Then, the paint is applied by inclined coating so that the film thickness continuously varies, and the paint is dried or cured. The coating surface is then visually observed under diffused daylight, and the minimum film thickness in which the monochrome border of the checker of the hiding power test paper disappears is measured with an electromagnetic film thickness meter. The measured value is the film thickness having hiding power of color.

The method for forming a multilayer coating film according to an embodiment of the present invention may include the step of applying the base paint (D) to the intermediate coating film to form a base coating film, as shown in process II, IV, or VI above.

The base paint (D) for use may be a known paint. In particular, the base paint (D) for use is preferably a paint typically used, for example, in coating vehicle bodies.

The base paint (D) is preferably a paint containing a base resin, a crosslinking agent, and a medium composed of water and/or an organic solvent.

The base resin and crosslinking agent for use may be known compounds commonly used in the art.

The base resin is preferably a resin excellent in weatherability and transparency. Specifically, the base resin includes an acrylic resin, a polyester resin, an epoxy resin, and a urethane resin.

The base paint (D) may be an aqueous paint or a solvent-based paint. From the standpoint of decreasing VOCs of the paint, the base paint (D) is preferably an aqueous paint. When the base paint (D) is an aqueous paint, the base resin for use can be a resin that contains hydrophilic groups (e.g., a carboxyl group, a hydroxyl group, a methylol group, an amino group, a sulfonate group, and a polyoxyethylene group; most preferably a carboxyl group) in an amount sufficient to solubilize or disperse the resin in water. By neutralizing the hydrophilic groups to transform the system into an alkali salt, the base resin can be solubilized or dispersed in water. The amount of hydrophilic groups, such as carboxyl groups, in doing this is not particularly limited, and can be freely determined depending on the solubility or dispersity in water. The amount of hydrophilic groups is typically about 10 mg KOH/g or more, and preferably 30 to 200 mg KOH/g, based on the acid value. Examples of alkaline substances for use in neutralization include sodium hydroxide and amine compounds.

The resin can be dispersed in water by subjecting the monomer component to emulsion polymerization in the presence of a surfactant and an optional water-soluble resin. The aqueous dispersion of the resin can also be obtained by dispersing the resin in water in the presence of, for example, an emulsifier. In the case of resin dispersion in water, the base resin may be completely free of hydrophilic groups or may contain hydrophilic groups in an amount smaller than the amount of the water-soluble resin described above.

The crosslinking agent is for use in crosslinking and curing the base resin by heating. Examples include amino resins, polyisocyanate compounds (including unblocked polyisocyanate compounds and blocked polyisocyanate compounds), epoxy group-containing compounds, carboxy-containing compounds, carbodiimide group-containing compounds, hydrazide group-containing compounds, and semicarbazide group-containing compounds. Of these, amino resins and polyisocyanate compounds, which are reactive with hydroxyl groups, and carbodiimide group-containing compounds, which are reactive with carboxyl groups, are preferable. These crosslinking agents may be used singly, or in a combination of two or more.

Specifically, amino resins obtained by condensation or co-condensation of, for example, melamine, benzoguanamine, or urea with formaldehyde, or amino resins obtained by further etherifying such amino resins with a lower monohydric alcohol, are suitably used. Additionally, polyisocyanate compounds are also suitably used.

The proportion of each component of the base paint (D) can be freely determined. However, from the standpoint of, for example, water resistance and appearance, it is preferred that the proportion of the base resin be typically 50 to 90 mass %, and particularly 60 to 85 mass %, based on the total mass of the base resin and crosslinking agent; and that the proportion of the crosslinking agent be typically 10 to 50 mass %, and particularly 15 to 40 mass %, based on the total mass of the base resin and crosslinking agent.

For the base paint (D), an organic solvent may optionally be used. Specifically, organic solvents typically used in paints are usable. Examples of organic solvents include hydrocarbons, such as toluene, xylene, hexane, and heptane; esters, such as ethyl acetate, butyl acetate, ethylene glycol monomethyl ether acetate, diethylene glycol monoethyl ether acetate, and diethylene glycol monobutyl acetate; ethers, such as ethylene glycol monomethyl ether, ethylene glycol diethyl ether, diethylene glycol monomethyl ether, and diethylene glycol dibutyl ether; alcohols, such as butanol, propanol, octanol, cyclohexanol, and diethylene glycol; and ketones, such as methyl ethyl ketone, methyl isobutyl ketone, cyclohexanone, and isophorone. These organic solvents may be used singly, or in a combination of two or more.

The base paint (D) may contain, for example, a color pigment, an extender pigment, an ultraviolet absorber, an antifoaming agent, a rheology control agent, a rust inhibitor, and a surface-adjusting agent, as necessary, in addition to the components described above.

The base paint (D) is preferably a transparent paint or a colored paint.

When the base paint (D) is a transparent paint, the base resin (D) may optionally contain an extender pigment without containing a color pigment. Examples of extender pigments include barium sulfate, barium carbonate, calcium carbonate, aluminum silicate, silica, magnesium carbonate, talc, and alumina white.

When the base paint (D) contains an extender pigment, the amount of the extender pigment is preferably 0.1 to 30 parts by mass, and more preferably 0.1 to 20 parts by mass, per 100 parts by mass of the resin solids in the base paint (D).

When the base paint (D) is a colored paint, the base paint (D) contains a color pigment. From the standpoint of light transmission control, the base paint (D) may contain a color pigment, such as titanium oxide and carbon black, and may further optionally contain a known color pigment, other than titanium oxide and carbon black. The color pigment is not particularly limited. Specifically, one pigment, or a combination of two or more pigments, can be selected from, for example, composite metal oxide pigments (e.g., iron oxide pigments and titanium yellow), azo pigments, quinacridone pigments, diketopyrrolopyrrole pigments, perylene pigments, perinone pigments, benzimidazolone pigments, isoindoline pigments, isoindolinone pigments, metal chelate azo pigments, phthalocyanine pigments, indanthrone pigments, dioxane pigments, threne pigments, indigoid pigments, and effect pigments. The effect pigment for use includes those listed as examples in the Colored Paint (W) section. When the base paint (D) contains a blue pigment as a color pigment, the blue pigment includes a phthalocyanine pigment, a threne pigment, and an indigoid pigment.

When the base paint (D) contains one or more pigments, the total content of the pigments may be typically within the range of 1 to 500 parts by mass, preferably 5 to 250 parts by mass, and more preferably 10 to 200 parts by mass, per 100 parts by mass of the total resin solids in the base paint (D).

When the base paint (D) contains a color pigment, the amount of the color pigment is preferably within the range of 0.1 to 50 parts by mass, and more preferably 0.2 to 40 parts by mass, per 100 parts by mass of the resin solids in the base paint (D).

From the standpoint of excellent darkness and a high degree of lightness and chroma in highlight of the obtained multilayer coating film, the thickness of a cured base coating film obtained from the base paint (D) is preferably 3 μm or more, more preferably 3 to 20 μm, and still more preferably 5 to 15 μm.

The base paint (D) can be applied by a typical method commonly used in the art. Examples include methods such as air-spray coating, airless spray coating, and rotary-atomization coating. When applying the base paint (D), electrostatic charge may optionally be applied. In particular, rotary-atomization electrostatic coating and air-spray electrostatic coating are preferable, with rotary-atomization electrostatic coating being particularly preferable.

When air-spray coating, airless spray coating, or rotary-atomization coating is performed, it is preferred that the base paint (D) be adjusted to have a solids content and a viscosity suitable for coating by adding water and/or an organic solvent, and optional additives such as a rheology control agent and an antifoaming agent.

The base paint (D) has a solids content of 10 to 60 mass %, preferably 15 to 55 mass %, and still more preferably 20 to 50 mass %. The base paint (D) has a viscosity of preferably 200 to 7000 cps, more preferably 300 to 6000 cps, and still more preferably 500 to 5000 cps, as measured with a Brookfield viscometer at 20° C. and at 6 rpm.

The method for forming a multilayer coating film according to an embodiment of the present invention includes, for example, the step of applying the metallic base paint (A) to a base coating film or an intermediate coating film to form a metallic base coating film, as shown in processes I to VI. The metallic base paint (A) is described above.

The metallic base paint (A) can be applied by a method such as electrostatic coating, air spray, airless spray, rotary-atomization coating, or curtain coating. In particular, rotary-atomization electrostatic coating is preferably used in the method for forming a multilayer coating film according to the present invention.

The metallic base coating film obtained by applying the metallic base paint (A) is preferably dry. The method for drying the metallic base coating film is not particularly limited. Examples include a method in which the film is allowed to stand at room temperature for 15 to 30 minutes, and a method in which a film is preheated at a temperature of 50 to 100° C. for 30 seconds to 10 minutes.

The method for forming a multilayer coating film according to an embodiment of the present invention may include the step of applying the clear paint (E) or the transparent colored paint (B) to the metallic base coating film to form a clear coating film or a transparent colored coating film, as shown in processes I to VI above.

The transparent colored paint (B) is described above.

The clear paint (E) may be a single-component clear paint containing a base resin and a crosslinking agent, or a two-component clear paint containing a hydroxy-containing resin and a polyisocyanate compound.

The clear paint (E) is an organic solvent-based or water-based, thermosetting paint that contains resin components such as a base resin and a crosslinking agent, and a solvent such as an organic solvent and water; and that may further optionally contain, for example, a color pigment, an ultraviolet absorber, and a light stabilizer. The clear paint (E) has such transparency that metallic feel of the lower-layer metallic base coating film can be visually perceived through a clear coating film obtained from this paint. The formulation of the clear paint (E) can be determined by suitably selecting components from among those described as components of the transparent colored clear paint (B2).

Typically, the amount of the clear paint (E) and the transparent colored paint (B) applied is preferably determined such that each of the cured films has a thickness of about 10 to 50 μm.

The clear paint (E) or transparent colored paint (B) can be applied by any method, and may be applied by the same method as for the metallic base paint (A). For example, the clear paint (E) or transparent colored paint (B) can be applied by a coating method such as electrostatic coating, air spraying, airless spraying, rotary-atomization coating, or curtain coating.

After the clear paint (E) or transparent colored paint (B) is applied to form a clear coating film or transparent colored coating film, preheating, for example, at a temperature of about 50 to 80° C. for about 3 to 10 minutes may be performed in order to facilitate volatilization of volatile components.

The method for forming a multilayer coating film according to an embodiment of the present invention may include the step of forming the clear paint (E) on the transparent colored coating film, as shown in processes I, III, IV, and VI. The clear paint (E) formed on the transparent colored coating film may be of the same formulation as that of the clear paint (E) formed on the metallic base coating film, or may be of a different formulation. For convenience, the same formulation is preferable. The method for applying the clear paint (E) is as described above.

Heating for baking can be performed by a known means. For example, heating can be performed with a drying furnace, such as a hot-blast furnace, an electric furnace, or an infrared-guided heating furnace.

The heating temperature is preferably within the range of 70 to 180° C., and more preferably 80 to 170° C.

The heating time period is not particularly limited, and is preferably within the range of 10 to 60 minutes, more preferably to 40 minutes, and particularly preferably 20 to 30 minutes. The curing (baking) time period can be changed, for example, depending on the curing temperature, and is preferably within the range of about 10 to 40 minutes at 100 to 170° C.

The measurement of C*15, C*25, C*45, L*15, L*25, and L*45 of the multilayer coating film can be performed on the multilayer coating film according to the present invention. The present invention also includes the following subject matter.

(1) A multilayer coating film comprising
a metallic base coating film, and
a transparent colored coating film that contains a blue pigment and that is disposed on the metallic base coating film,
   wherein

the value of hue angle h in an L*C*h color space diagram of the multilayer coating film is within the range of 225° to 300°, and

when X=C*45/L*45 and Y=[(L*15)²+(C*15)²)]^{1/2}+[(L*25)²+(C*25)²)]^{1/2}, X is 2 to 20 and Y is 50 to 250,

provided that C*15, C*25, and C*45 each represent a chroma of the multilayer coating film calculated from a spectral reflectance of light illuminated at an incident angle of 45° with respect to the multilayer coating film and received at angles of 15°, 25°, and 45° deviated from specular reflection light, and that L*15, L*25, and L*45 each represent a lightness of the multilayer coating film calculated from a spectral reflectance of light illuminated at an incident angle of 45° with respect to the multilayer coating film and received at angles of 15°, 25° and 45° deviated from specular reflection light.

(2) The multilayer coating film according to (1), wherein X is 4 to 15, and Y is 100 to 200.
(3) The multilayer coating film according to (1), wherein X is 9 to 12, and Y is 150 to 180.
(4) The multilayer coating film according to any one of (1) to (3), wherein the metallic base coating film contains an aluminum flake pigment, a surface-adjusting agent, and a rheology control agent.
(5) The multilayer coating film according to any one of (1) to (4), wherein the transparent colored coating film contains a resin component and 0.5 to 10 parts by mass of the blue pigment, per 100 parts by mass of resin solids of the transparent colored coating film.
(6) The multilayer coating film according to any one of (1) to (5), wherein the blue pigment contains at least one member selected from the group consisting of a phthalocyanine pigment and a threne pigment.
(7) The multilayer coating film according to any one of (1) to (6), further comprising a clear coating film on the transparent colored coating film.
(8) The multilayer coating film according to any one of (4) to (7), wherein the surface-adjusting agent is one member, or two or more members, selected from the group consisting of a silicone-based surface-adjusting agent, an acrylic-based surface-adjusting agent, a vinyl-based surface-adjusting agent, a fluorine-based surface-adjusting agent, and an acetylene diol-based surface-adjusting agent.
(9) The multilayer coating film according to any one of (4) to (8), wherein the rheology control agent contains a cellulose-based rheology control agent.
(10) The multilayer coating film according to any one of (1) to (9), wherein the metallic base coating film has a thickness of 0.02 to 5 μm on a dry film basis.
(11) The multilayer coating film according to any one of (1) to (10), wherein the transparent colored coating film has a thickness of 10 to 100 μm on a dry film basis.
(12) The multilayer coating film according to any one of (1) to (11), which has any one of the configurations 1-1 to 10-104 above.
(13) The multilayer coating film according to any one of (1) to (11), which has any one of the following configurations 1 to 6:
1. an intermediate coating film, a metallic base coating film, a clear coating film, a transparent colored coating film, a clear coating film;
2. an intermediate coating film, a base coating film, a metallic base coating film, a clear coating film, a transparent colored coating film, a clear coating film;
3. an intermediate coating film, a metallic base coating film, a colored clear coating film, a transparent colored coating film, a colored clear coating film;
4. an intermediate coating film, a base coating film, a metallic base coating film, a colored clear coating film, a transparent colored coating film, a colored clear coating film;
5. an intermediate coating film, a metallic base coating film, a colored clear coating film;
6. an intermediate coating film, a base coating film, a metallic base coating film, a colored clear coating film.
(14) An object comprising the multilayer coating film of any one of (1) to (13).
(15) A method for forming a multilayer coating film comprising the following steps (1) to (3):

step (1) of applying a metallic base paint to a substrate to form a metallic base coating film,

step (2) of applying a transparent colored paint that contains a blue pigment to the metallic base coating film to form a transparent colored coating film that contains the blue pigment, and,

step (3) of separately or concurrently heating the metallic base coating film formed in step (1) and the transparent colored coating film that contains the blue pigment formed in the step (2) to cure the coating films,

wherein

the value of hue angle h in an L*C*h color space diagram of the multilayer coating film is within the range of 225° to 300°, and

when X=C*45/L*45 and Y=[(L*15)²+(C*15)²)]^{1/2}+[(L*25)²+(C*25)²)]^{1/2}, X is 2 to 20 and Y is 50 to 250,

provided that C*15, C*25, and C*45 each represent a chroma of the multilayer coating film calculated from a spectral reflectance of light illuminated at an incident angle of 45° with respect to the multilayer coating film and received at angles of 15°, 25°, and 45° deviated from specular reflection light, and that L*15, L*25, and L*45 each represent a lightness of the multilayer coating film calculated from a spectral reflectance of light illuminated at an incident angle of 45° with respect to the multilayer coating film and received at angles of 15°, 25° and 45° deviated from specular reflection light.

(16) The method for forming a multilayer coating film according to (15), wherein the metallic base paint contains water, 0.2 to 6 parts by mass of an aluminum flake pigment on a solids basis per
100 parts by mass of the metallic base paint, a surface-adjusting agent, and a rheology control agent.
(17) The method for forming a multilayer coating film according to (15), wherein X is 4 to 15, and Y is 100 to 200.
(18) The method for forming a multilayer coating film according to (15), wherein X is 9 to 12, and Y is 150 to 180.
(19) The method for forming a multilayer coating film according to any one of (15) to (18), wherein the blue pigment has a haze value of 0 to 50.
(20) The method for forming a multilayer coating film according to any one of (15) to (19), wherein the transparent colored coating film contains a resin component, and 0.5 to 10 parts by mass of the blue pigment, per 100 parts by mass of resin solids of the transparent colored coating film.
(21) The method for forming a multilayer coating film according to any one of (15) to (20), wherein the blue pigment contains at least one member selected from the group consisting of a phthalocyanine pigment and a threne pigment.
(22) The method for forming a multilayer coating film according to (15) to (21), wherein the metallic base coating film contains an aluminum flake pigment, a surface-adjusting agent, and a rheology control agent.
(22) The method for forming a multilayer coating film according to any one of (15) to (21), wherein after being cured, the metallic base coating film has a thickness of 0.02 to 5 μm.
(23) The method for forming a multilayer coating film according to any one of (15) to (22), wherein the transparent colored coating film has a thickness of 10 to 100 μm on a dry film basis.

Below, the present invention is described in more detail with reference to Production Examples, Examples, and Comparative Examples. These Production Examples, Examples, and Comparative Examples are merely examples, and are not intended to restrict the scope of the present invention. In the Production Examples, Examples, and Comparative Examples, parts and percentage are based on mass unless otherwise specified. The thickness of a coating film is based on its cured coating film.

### EXAMPLES

### 1. Preparation of Metallic Base Paint (A)

### (1) Preparation of Acrylic Resin Aqueous Dispersion (R-1)

### Production Example 1

128 parts of deionized water and 2 parts of Adeka Reasoap SR-1025 (trade name, produced by Adeka, emulsifier, active ingredient: 25%) were placed in a reaction vessel equipped with a thermometer, a thermostat, a stirrer, a reflux condenser, a nitrogen inlet tube, and a dropping funnel. The mixture was stirred and mixed in a nitrogen flow, and heated to 80° C.

Subsequently, 1% of the entire amount of a monomer emulsion for the core portion, which is described below, and 5.3 parts of a 6% ammonium persulfate aqueous solution were introduced into the reaction vessel, and maintained at 80° C. for 15 minutes. Thereafter, the remaining monomer emulsion for the core portion was added dropwise over a period of 3 hours to the reaction vessel maintained at the same temperature. After completion of the dropwise addition, the mixture was aged for 1 hour. A monomer emulsion for the shell portion, which is described below, was then added dropwise over a period of 1 hour, followed by aging for 1 hour. The mixture was then cooled to 30° C. while gradually adding 40 parts of a 5% 2-(dimethylamino)ethanol aqueous solution to the reaction vessel, and the resulting mixture was filtered through a 100-mesh nylon cloth and discharged, thereby obtaining an acrylic resin aqueous dispersion (R-1) having an average particle size of 100 nm and a solids content of 30%. The obtained acrylic resin aqueous dispersion had an acid value of 33 mgKOH/g and a hydroxy value of 25 mgKOH/g.

Monomer emulsion for the core portion: The monomer emulsion for the core portion was obtained by mixing and stirring 40 parts of deionized water, 2.8 parts of Adeka Reasoap SR-1025, 2.1 parts of methylene bisacrylamide, 2.8 parts of styrene, 16.1 parts of methyl methacrylate, 28 parts of ethyl acrylate, and 21 parts of n-butyl acrylate.

Monomer emulsion for the shell portion: The monomer emulsion for the shell portion was obtained by mixing and stirring 17 parts of deionized water, 1.2 parts of Adeka Reasoap SR-1025, 0.03 parts of ammonium persulfate, 3 parts of styrene, 5.1 parts of 2-hydroxyethyl acrylate, 5.1 parts of methacrylic acid, 6 parts of methyl methacrylate, 1.8 parts of ethyl acrylate, and 9 parts of n-butyl acrylate.

### (2) Production of Metallic Base Paint (A)

### Production Example 2

The following components were placed in a stirring vessel and mixed by stirring to prepare a metallic base paint (A-1; see Table 1).
Distilled water: 76.7 parts
Rheology control agent

Rheocrysta (trade name, produced by DKS Co., Ltd., cellulose nanofibers, solids content: 2%): 0.5 parts on a solids basis
Aluminum flake pigments

Hydroshine (registered trademark) WS-3001 (trade name, PVD (physical vapor deposition) aluminum flake pigment, produced by Eckart, solids content: 10%, internal solvent: isopropanol, average particle diameter D50: 11 μm, thickness: 0.05 μm, surface treated with silica): 1.2 parts on a solids basis

Alpaste EMR-B6360 (trade name, produced by Toyo Aluminium K.K., a non-leafing aluminum flake, average particle size D50: 10.3 μm, thickness: 0.19 μm, surface treated with silica): 0.37 parts on a solids basis
Resin aqueous dispersion

Acrylic resin aqueous dispersion (R-1): 0.67 parts on a solids basis
Solvents

Isopropanol: 19.5 parts

Octanol: 0.51 parts
Surface conditioner

Dynol 604 (trade name, acetylene diol wetting agent, produced by Evonik Industries, solids content: 100%): 0.25 parts on a solids basis
UV absorber

Tinuvin 479-DW (trade name, UV absorber, BASF, hydroxyphenyltriazine-based UV absorber, HPT-based W absorber Tinuvin 479 contained in an acrylic polymer, solids content: 40%): 0.14 parts on a solids basis,
Light stabilizer

Tinuvin 123-DW (trade name, light stabilizer, produced by BASF, decanedioic acid bis(2,2,6,6-tetramethyl-1-(octyloxy)-4-piperidinyl) ester; HALS Tinuvin 123 having an amino ether group is included in an acrylic polymer (solid content 50%): 0.11 parts on a solids content.

### Production Example 3

A metallic base paint (A-2) was produced in the same manner as in Production Example 9 except that that the amount of the effect pigment Hydroshine (registered trademark) WS-3001 was changed to 1.57 parts on a solids basis, and the amount of Alpaste EMR-B6360 was changed to 0 parts on a solids basis.

### Production Example 4

WBC-713T No. 176 (trade name, produced by Kansai Paint Co., Ltd., an acrylic melamine resin-based aqueous base paint, silver paint color, containing 10 parts by mass of Alpaste EMR-B6360 on a solids content per 100 parts by mass of the resin, was used as metallic base paint (A-3).

TABLE 1

| | | Production | | | |
|---|---|---|---|---|---|
| | | Example No. | | | |
| | | 2 | | 3 | |
| | | Name of metallic | | | |
| | | base paint (A) | | | |
| | | A-1 | | A-2 | |
| | | Mass | Solids | Mass | Solids |
| Distilled water | | 76.7 | | 76.7 | |
| Wetting agent | Dynol604 | | 0.25 | | 0.25 |
| Aluminum | Hydroshine | | 1.2 | | 1.57 |
| flake | WS3001 | | | | |
| pigment | Alpaste | | 0.37 | | 0 |
| | EMR-B6360 | | | | |
| Cellulose-based | Rheocrysta | | 0.5 | | 0.5 |
| rheology | | | | | |
| control agent | | | | | |
| UV absorber | Tinuvin | | 0.14 | | 0.14 |
| | 479-DW | | | | |
| Light | Tinuvin | | 0.11 | | 0.11 |
| stabilizer | 123-DW | | | | |
| Resin water | Acrylic resin | | 0.67 | | 0.67 |
| dispersion | water | | | | |
| | dispersion | | | | |
| | (R-1) | | | | |
| Solvent | Isopropanol | 19.5 | | 19.5 | |
| | Octanol | 0.51 | | 0.51 | |

| | | |
|---|---|---|
| Solids content % | 3.2 | 3.2 |
| B6/mPa · S | 2300 | 2300 |
| Percentage of effect pigment in | 48% | 48% |
| the paint on a solids basis | | |
| Proportion of wetting agent | 16 | 16 |
| relative to the effect pigment | | |
| on a solids basis | | |
| Percentage of wetting agent in | 8% | 8% |
| the paint on a solids basis | | |
| Percentage of CNF in the paint | 15% | 15% |
| on a solids basis | | |
| Percentage of Em in the paint | 21% | 21% |
| on a solids basis | | |

### 2. Production of Transparent Colored Paint (B)

### (1) Production of Resin for Pigment Dispersion

### Production Example 5

18.2 parts of ethylene glycol monobutyl ether and 11.8 parts of 2,4-diphenyl-4-methyl-1-pentene were placed in a reaction vessel equipped with a thermometer, a thermostat, a stirring device, a reflux condenser, and a dropping device. After stirring and mixing in a nitrogen flow and heating to 120° C., a monomer mixture described below was added dropwise over a period of 6 hours and aged at 120° C. for 30 minutes.

### Composition of Monomer Mixture I

| | | |
|---|---|---|
| Methyl methacrylate | 87 | parts |
| N,N-dimethylaminoethyl methacrylate | 12 | parts |
| Tridecyl methacrylate | 0.5 | parts |
| Lauryl methacrylate | 0.5 | parts |
| 2,2′-azobis(2-methylbutyronitrile) | 3 | parts |
| Ethylene glycol monobutyl ether | 6 | parts |

Subsequently, the following additional catalyst mixture was added dropwise to the aged product over a period of 1 hour and aged at 120° C. for 1 hour. Thereafter, 18 parts of ethylene glycol monobutyl ether and 22.7 parts of propylene glycol monobutyl ether were added so that the solid content concentration was 60%, thus obtaining a solution of polymer A, which is a macromonomer. The obtained polymer A had a weight average molecular weight of about 3000.

### Additional Catalyst Mixture

| | | |
|---|---|---|
| 2,2′-Azobis(2-methylbutyronitrile) | 0.5 | parts |
| Ethylene glycol monobutyl ether | 9 | parts |

Subsequently, 41.7 parts of polymer A, which is a macromonomer, was placed into a reaction vessel equipped with a thermometer, a thermostat, a stirrer, a reflux condenser, and a dropping device, and stirred and mixed in a nitrogen stream. After the temperature of the resulting mixture had reached 95° C., monomer mixture II and monomer mixture III, which are described below, were added dropwise over a period of 3 hours and the resulting mixture was aged at 95° C. for 30 minutes.

### Composition of Monomer Mixture II

| | | |
|---|---|---|
| Methyl methacrylate | 45 | parts |
| 2-hydroxyethyl methacrylate | 10 | parts |
| 2,2′-Azobis(2-methylbutyronitrile) | 0.9 | parts |
| Propylene glycol monobutyl ether | 5 | parts |

### Composition of Monomer Mixture III

| | | |
|---|---|---|
| Methoxy polyethylene glycol methacrylate | 20 | parts |
| (molecular weight: about 2080) | | |
| Deionized water | 20 | parts |
| Ethylene glycol monobutyl ether | 5 | parts |

Subsequently, the following additional catalyst mixture was added dropwise to the aged product above over a period of 1 hour, followed by aging at 95° C. for 1 hour. 36 parts of propylene glycol monobutyl ether was then added to achieve a solids concentration of 53%, thus obtaining an AB block polymer solution. The obtained polymer had a weight average molecular weight of about 15000. This polymer is termed “hydroxy-containing acrylic resin (R-2).”

| | | |
|---|---|---|
| 2,2′-azobis(2-methylbutyronitrile) | 0.375 | parts |
| Prolene glycol monobutyl ether | 6 | parts |

### Production Example 6

35 parts of propylene glycol monopropyl ether was placed in a reaction vessel equipped with a thermometer, a thermostat, a stirrer, a reflux condenser, a nitrogen inlet tube, and a dropping funnel, and heated to 85° C. A mixture of 32 parts of methyl methacrylate, 27.7 parts of n-butyl acrylate, 20 parts of 2-ethylhexyl acrylate, 10 parts of 4-hydroxybutyl acrylate, 3 parts of hydroxypropyl acrylate, 6.3 parts of acrylic acid, 1 part of 2-acryloyloxyethyl acid phosphate, 15 parts of propylene glycol monopropyl ether, and 2.3 parts of 2,2′-azobis(2,4-dimethylvaleronitrile) was added dropwise over 4 hours. After the completion of dropwise addition, the mixture was aged for 1 hour. Thereafter, a mixture of 10 parts of propylene glycol monopropyl ether and 1 part of 2,2′-azobis(2,4-dimethylvaleronitrile) was further added dropwise over 1 hour. After the completion of dropwise addition, the mixture was aged for 1 hour. 7.4 parts of diethanolamine was further added, thereby obtaining a hydroxy-containing acrylic resin (R-3) solution with a solids content of 55%. The obtained hydroxy-containing acrylic resin (R-3) had an acid value of 51 mg KOH/g and a hydroxy value of 52 mg KOH/g.

### (2) Production of Pigment Dispersion

### Production Example 7

36 parts of the hydroxy-containing acrylic resin (R-2) (solids content: 19.1 parts), 15 parts of Palogen Blue L6482 (trade name, threne-based blue pigment, produced by BASF), and 36 parts of deionized water were placed in a stirring vessel and homogenously mixed. Further, 2-(dimethylamino)ethanol was added to adjust the pH to 7.5. The obtained mixture was placed in a 225-ml resin bottle, and 130 parts of zirconia beads (diameter: 1.5 mm) were added thereto, followed by hermetically sealing the bottle. The mixture was dispersed for 120 minutes with a paint shaker conditioner. After the dispersion, the zirconia beads were removed by filtration through 100-mesh metallic gauze, thus obtaining a blue pigment dispersion (P-1) with a solids content of 44%.

### Production Example 8

36 parts of a hydroxyl group-containing acrylic resin (R-3) (solid content 19.8 parts), 15 parts of Paliogen Blue L6482, and 36 parts of deionized water were placed in a stirring vessel and homogenously mixed. Further, 2-(dimethylamino)ethanol was added to adjust the pH to 7.5. The obtained mixture was placed in a 225-ml resin bottle, and 130 parts of zirconia beads (diameter: 1.5 mm) were added thereto, followed by hermetically sealing the bottle. The mixture was dispersed for 120 minutes using a paint shaker conditioner. After the dispersion, the zirconia beads were removed by filtration through 100-mesh metallic gauze, thus obtaining a blue pigment dispersion (P-2) with a solids content of 44%.

### Production Example 9

36 parts of the hydroxyl group-containing acrylic resin (R-2) (solids content: 19.1 parts), 15 parts of Chromofine Blue 5206M (trade name, produced by Dainichiseika Color & Chemicals Mfg. Co., Ltd., a phthalocyanine blue pigment), and 36 parts of deionized water were placed in a stirring vessel and homogenously mixed. Further, 2-(dimethylamino)ethanol was added to adjust the pH to 7.5. The obtained mixture was placed in a 225-ml resin bottle, and 130 parts of zirconia beads having a diameter of 1.5 mm were added thereto, followed by hermetically sealing the bottle. The mixture was dispersed for 120 minutes using a paint shaker conditioner. After the dispersion, the zirconia beads were removed by filtration through 100-mesh metallic gauze to obtain a blue pigment dispersion (P-3) with a solids content of 44%.

### Production Example 10

33.3 parts of Acrydic A430-60 (trade name, an acrylic resin solution, solids content: 60 mass %, produced by DIC), 3 parts of Solsperse 24000GR (trade name, a pigment dispersant, produced by Lubrizol), 8 parts of Paliogen Blue L6482 and 61.7 parts of ethylene glycol monoethyl ether acetate were placed in a 225-ml resin bottle. Further, 130 parts of zirconia beads (diameter: 1.5 mm) were added thereto, followed by hermetically sealing the bottle. The mixture was dispersed for 300 minutes using a paint shaker conditioner. After the dispersion, the zirconia beads were removed by filtration through 100-mesh metallic gauze, thus obtaining a blue pigment dispersion (P-4).

### (3) Production of Transparent Colored Paints

### Transparent Colored Paint (B-1)

A paint prepared by adding the blue pigment dispersion (P-1) in such an amount that 5 parts of Paliogen Blue L6482 was present per 100 parts by mass of the resin solids content of WBC-713T (trade name, produced by Kansai Paint Co., Ltd., an aqueous base paint for automobiles, pigment-free, colorless transparent).

### Transparent Colored Paint (B-2)

A paint prepared by adding the blue pigment dispersion (P-1) in such an amount that 10 parts of Paliogen Blue L6482 was present per 100 parts by mass of the resin solids content of WBC-713T (trade name, produced by Kansai Paint Co., Ltd., an aqueous base paint for automobiles, pigment-free, colorless transparent).

### Transparent Colored Paint (B-3)

A paint prepared by adding the blue pigment dispersion (P-1) in such an amount that 3 parts of Paliogen Blue L6482 was present per 100 parts by mass of the resin solids content of WBC-713T (trade name, produced by Kansai Paint Co., Ltd., an aqueous base paint for automobiles, pigment-free, colorless transparent).

### Transparent Colored Paint (B-4)

A paint prepared by adding the blue pigment dispersion (P-1) in such an amount that 5 parts of Paliogen Blue L6482 was present per 100 parts by mass of the resin solids content of WBC-713T (trade name, produced by Kansai Paint Co., Ltd., an aqueous base paint for automobiles, pigment-free, colorless transparent) and further adding 1 part of Metashine ST1018RS (trade name, produced by Nippon Sheet Glass Co., Ltd., a glass flake pigment).

### Transparent Colored Paint (B-5)

A paint prepared by adding the blue pigment dispersion (P-1) in such an amount that 5 parts of Paliogen Blue L6482 was present and further adding 1 part of Xirallic Galaxy Blue T60-23 (trade name, produced by Merck & Co., Inc., a metal oxide-coated alumina flake pigment) per 100 parts by mass of the resin solids content of WBC-713T (trade name, produced by Kansai Paint Co., Ltd., an aqueous base paint for automobiles, pigment-free, colorless transparent).

### Transparent Colored Paint (B-6)

A paint prepared by adding the blue pigment dispersion (P-2) in such an amount that 5 parts of Paliogen Blue L6482 was present per 100 parts by mass of the resin solids content of WBC-713T (trade name, produced by Kansai Paint Co., Ltd., an aqueous base paint for automobiles, pigment-free, colorless transparent).

### Transparent Colored Paint (B-7)

A paint prepared by adding the blue pigment dispersion (P-3) in such an amount that 5 parts of Chromofine Blue 5206M was present per 100 parts by mass of the resin solids content of WBC-713T (trade name, produced by Kansai Paint Co., Ltd., an aqueous base paint for automobiles, pigment-free, colorless transparent).

### Transparent Colored Paint (B-8)

A paint prepared by adding the blue pigment dispersion (P-1) in such an amount that 15 parts of Paliogen Blue L6482 was present per 100 parts by mass of the resin solids content of WBC-713T (trade name, produced by Kansai Paint Co., Ltd., an aqueous base paint for automobiles, pigment-free, colorless transparent).

### Transparent Colored Paint (B-9)

A paint prepared by adding the blue pigment dispersion (P-1) in such an amount that 1 part of Paliogen Blue L6482 was present per 100 parts by mass of the resin solids content of WBC-713T (trade name, produced by Kansai Paint Co., Ltd., an aqueous base paint for automobiles, pigment-free, colorless transparent).

### Transparent Colored Paint (B-10)

A paint prepared by adding the blue pigment dispersion (P-4) in such an amount that 0.5 parts of Paliogen Blue L6482 was present per 100 parts by mass of the resin solids content of KINO6510 (trade name, produced by Kansai Paint Co., Ltd., a hydroxy/isocyanate curable acrylic resin/urethane resin-based two-component organic solvent-based paint).

### Transparent Colored Paint (B-11)

A paint prepared by adding the blue pigment dispersion (P-4) in such an amount that 3 parts of Paliogen Blue L6482 was present per 100 parts by mass of the resin solids content of KINO6510 (trade name, produced by Kansai Paint Co., Ltd., a hydroxy/isocyanate curable acrylic resin/urethane resin-based two-component organic solvent-based paint).

### 3. Production of Intermediate Paint

### Intermediate Paint (C-1)

WP-505T (trade name, produced by Kansai Paint Co., Ltd., an aqueous intermediate paint, L* value of the obtained coating film: 60)

### Intermediate Paint (C-2)

TP-65 No. 8101 (trade name, produced by Kansai Paint Co., Ltd., a solvent-based intermediate paint, L* value of the obtained coating film: 60)

### 4. Production of Base Paint

### (1) Preparation of Extender Pigment Dispersion (P-5)

### Production Example 11

327 parts (solids content: 180 parts) of the hydroxy-containing acrylic resin solution (R-3), 360 parts of deionized water, 6 parts of Surfynol (registered trademark) 104A (trade name, an antifoaming agent produced by Evonik Industries AG, solids content: 50%), and 250 parts of Barifine BF-20 (trade name, produced by Sakai Chemical Industry Co., Ltd., barium sulfate powder, average particle size: 0.03 μm) were placed in a resin bottle. A glass bead medium was added thereto, followed by hermetically sealing the bottle. The mixture was mixed and dispersed at room temperature for 1 hour using a paint shaker conditioner. After the dispersion, the glass beads were removed to obtain an extender pigment dispersion (P-5) having a solids content of 44%.

### (2) Production of Polyester Resin (R-4)

### Production Example 12

109 parts of trimethylolpropane, 141 parts of 1,6-hexanediol, 126 parts of 1,2-cyclohexanedicarboxylic acid anhydride, and 120 parts of adipic acid were placed into a reaction vessel equipped with a thermometer, a thermostat, a stirrer, a reflux condenser, and a water separator. The mixture was heated from 160° C. to 230° C. over a period of 3 hours, followed by a condensation reaction at 230° C. for 4 hours. Subsequently, to introduce a carboxyl group to the obtained condensation reaction product, 38.3 parts of trimellitic anhydride was added to the product, followed by a reaction at 170° C. for 30 minutes. Thereafter, the product was diluted with 2-ethyl-1-hexanol, thereby obtaining a polyester resin solution (R-4) having a solids content of 70%. The obtained hydroxy-containing polyester resin had an acid value of 46 mgKOH/g, a hydroxy value of 150 mgKOH/g, and a number average molecular weight of 1400.

### (3) Production of Base Paint

### Base Paint (D-1)

### Production Example 13

In a stirring vessel, 14 parts (on a solids basis) of the extender pigment dispersion (P-5), 40 parts (on a solids basis) of the acrylic resin aqueous dispersion (R-1), 23 parts (on a solids basis) of the polyester resin solution (R-4), 10 parts (on a solids basis) of U-Coat UX-310 (trade name, produced by Sanyo Chemical Industries, Ltd., a urethane resin aqueous dispersion, solids content: 40%), and 27 parts (on a solids basis) of Cymel 251 (trade name, produced by Nihon Cytec Industries Inc., a melamine resin, solids content: 80%) were stirred and mixed, thus preparing a transparent base paint (D-1).

### 5. Production of Clear Paint

### Clear Paint (E-1)

KINO6510 (trade name, produced by Kansai Paint Co., Ltd., a hydroxy/isocyanate curable acrylic resin/urethane resin-based two-component organic solvent-based paint)

### 6. Preparation of Object

A steel plate degreased and treated with zinc phosphate (JISG3141, size: 400 m×300 m×0.8 m) was coated with Elecron GT-10 cationic electrodeposition paint (trade name: produced by Kansai Paint Co., Ltd., an epoxy-resin polyamine-based cationic resin containing a block polyisocyanate compound as a crosslinking agent) by electrodeposition such that the coated film had a film thickness of 20 μm on a cured coating film basis. The coated film was heated at 170° C. for 20 minutes to allow the coated film to be crosslinked and cured, thereby forming an electrodeposition coating film, which was used as substrate 1 to be coated.

### 7. Preparation of Test Plates

### Example 1

Step (1): The intermediate paint (C-1) was electrostatically applied to substrate 1 to a cured film thickness of 35 μm using a rotary-atomization bell coater. After being allowed to stand for 3 minutes, the film was preheated at 80° C. for 3 minutes, thereby forming an uncured intermediate coating film.

Step (2): Further, the metallic base paint (A-1), prepared as described above, was applied to the obtained uncured intermediate coating film to a film thickness of 1.0 μm on a dry coating film basis at a booth temperature of 23° C. and a humidity of 68% using a Robot Bell (produced by ABB). The film was allowed to stand for 3 minutes, and then preheated at 80° C. for 3 minutes, thereby forming an uncured metallic base coating film.

Step (3): Subsequently, the clear paint (E-1) was applied to this uncured metallic coating film to a film thickness of 25 μm on a dry coating film basis at a booth temperature of 23° C. and a humidity of 68% using a Robot Bell (produced by ABB), thereby forming a clear coating film 1. After the coating, the coated film was allowed to stand at room temperature for 7 minutes, and then heated using a hot-air-circulation drying oven at 140° C. for 30 minutes to dry the three-layered coating film simultaneously, thereby forming a multilayer coating film.

Step (4): Subsequently, the transparent colored paint (B-1) was applied to this multilayer coating film to a film thickness of 15 μm on a cured coating film basis using a rotary-atomization electrostatic coater. After being allowed to stand for 3 minutes, the film was preheated at 80° C. for 3 minutes, thereby forming an uncured transparent colored coating film.

Step (5): Further, the clear paint (E-1) was applied to the obtained uncured transparent colored coating film to a film thickness of 35 μm on a dry coating film basis at a booth temperature of 23° C. and a humidity of 68% using a Robot Bell (produced by ABB), thereby forming a clear coating film 2. After the coating, the film was allowed to stand at room temperature for 7 minutes, and then heated using a hot-air-circulation drying oven at 140° C. for 30 minutes to simultaneously dry the two-layered coating film. The obtained film was used as a test plate.

The film thickness of the metallic base coating films shown in Table 2 was calculated from the following Formula (2). The same applies to the following Examples.

x=(sc*10000)/(S*sg) (2)

x: film thickness (μm)
sc: coating solids content (g)
S: evaluation area of coating solids content (cm²)
sg: specific gravity of the coating film (g/cm³)

### Examples 2 to 8 and Comparative Examples 1 to 2

Test plates were obtained in the same manner as in Example 1 except that the compositions for paints were changed as shown in Table 2.

### Comparative Example 3

Step (1): The intermediate paint (C-1) was electrostatically applied to substrate 1 to a cured film thickness of 35 μm using a rotary-atomization bell coater. After being allowed to stand for 3 minutes, the film was preheated at 80° C. for 3 minutes, thereby forming an uncured intermediate coating film.

Step (2): Further, the metallic base paint (A-3), prepared as described above, was applied to the obtained uncured intermediate coating film to a film thickness of 15 μm on a dry coating film basis at a booth temperature of 23° C. and a humidity of 68% using a Robot Bell (produced by ABB). The film was allowed to stand for 3 minutes, and then preheated at 80° C. for 3 minutes, thereby forming an uncured metallic base coating film.

Step (3): Subsequently, clear paint 1 (E-1) was applied to this uncured metallic coating film to a film thickness of 25 μm on a dry coating film basis at a booth temperature of 23° C. and a humidity of 68% using a Robot Bell (produced by ABB), thereby forming a clear coating film 1. After the coating, the coated film was allowed to stand at room temperature for 7 minutes, and then heated using a hot-air-circulation drying oven at 140° C. for

30 minutes to simultaneously dry the three-layered coating film, thereby forming a multilayer coating film.

Step (4): Subsequently, the transparent colored paint (B-1) was applied to this multilayer coating film to a film thickness of 15 μm on a cured coating film basis using a rotary-atomization electrostatic coater. After being allowed to stand for 3 minutes, the film was preheated at 80° C. for 3 minutes, thereby forming an uncured transparent colored coating film.

Step (5): Further, clear paint 2 (E-1) was applied to the obtained uncured transparent colored coating film to a film thickness of 35 μm on a dry coating film basis at a booth temperature of 23° C. and a humidity of 68% using a Robot Bell (produced by ABB), thereby forming a clear coating film 2. After the coating, the film was allowed to stand at room temperature for 7 minutes, and then heated using a hot-air-circulation drying oven at 140° C. for 30 minutes to simultaneously dry the two-layered coating film. The obtained film was used as a test plate.

### Example 9

Step (1): The intermediate paint (C-2) was electrostatically applied to substrate 1 to a cured film thickness of 35 μm using a rotary-atomization-bell coater, and heated at 140° C. for 30 minutes to allow the film to be crosslinked and cured.

Step (2): Subsequently, the transparent base paint (D-1) was electrostatically applied to the cured coating film to a cured film thickness of 10 μm using a rotary-atomization bell coater, and allowed to stand for 2 minutes.

Step (3): Further, the metallic base paint (A-1) was adjusted to have a paint viscosity shown in Table 1, and applied to the coating film to a film thickness of 1.0 μm on a dry coating film basis at a booth temperature of 23° C. and a humidity of 68% using a Robot Bell (produced by ABB). After being allowed to stand for 3 minutes, the film was preheated at 80° C. for 3 minutes to form an uncured metallic base coating film.

Step (4): Subsequently, clear paint 1 (E-1) was applied to this uncured metallic coating film to a film thickness of 25 μm on a dry coating film basis at a booth temperature of 23° C. and a humidity of 68% using a Robot Bell (produced by ABB), thereby forming a clear coating film 1. After the coating, the coated film was allowed to stand at room temperature for 7 minutes, and then heated using a hot-air-circulation drying oven at 140° C. for 30 minutes to simultaneously dry the three-layered coating film, thereby forming a multilayer coating film.

Step (5): Subsequently, a transparent colored paint (B-1) was applied to the multilayer coating film to a film thickness of 15 μm on a cured coating film basis using a rotary-atomization electrostatic coater. After being allowed to stand for 3 minutes, the film was preheated at 80° C. for 3 minutes, thereby forming an uncured transparent colored coating film.

Step (6): Further, clear paint 2 (E-1) was applied to the obtained uncured transparent colored coating film to a film thickness of 35 μm on a dry coating film basis at a booth temperature of 23° C. and a humidity of 68% using a Robot Bell (produced by ABB), thereby forming a clear coating film 2. After coating, the film was allowed to stand at room temperature for 7 minutes, and then heated using a hot-air-circulation drying oven at 140° C. for 30 minutes to simultaneously dry the two-layered coating film, thereby obtaining a test plate for use in Example 9.

### Examples 10 to 13 and Comparative Examples 4 and 5

Test plates were obtained in the same manner as in Example 9 except that the compositions for paints were changed as shown in Table 3.

### Example 14

Test plates were obtained in the same manner as in Example 1 except that the compositions for paints were changed as shown in Table 4. Table 5 shows the dry film thickness of each paint containing a blue pigment, the proportion of the blue pigment (parts by mass), and the optical density of the blue pigment in each coating film.

### Example 15

Test plates were obtained in the same manner as in Example 9 except that the compositions for paints were changed as shown in Table 6. Table 7 shows the dry film thickness of each paint containing a blue pigment, the proportion of the blue pigment (parts by mass), and the optical density of the blue pigment in each coating film.

### Example 16

Step (1): The intermediate paint (C-1) was electrostatically applied to substrate 1 to a cured film thickness of 35 μm using a rotary-atomization bell coater. After being allowed to stand for 3 minutes, the film was preheated at 80° C. for 3 minutes, thereby forming an uncured intermediate coating film.

Step (2): Further, the metallic base paint (A-1), prepared as described above, was applied to the obtained uncured intermediate coating film to a film thickness of 1.0 μm on a dry coating film basis at a booth temperature of 23° C. and a humidity of 68% using a Robot Bell (produced by ABB). After being allowed to stand for 3 minutes, the film was preheated at 80° C. for 3 minutes, thereby forming an uncured metallic base coating film.

Step (3): Subsequently, the transparent colored paint (B-11) was applied to the surface of the dry coating film to a film thickness of 35 μm on a dry coating film at a booth temperature of 23° C. and a humidity of 68% using a Robot Bell (produced by ABB). After the coating, the film was allowed to stand at room temperature for 7 minutes, and heated using a hot-air-circulation drying oven at 140° C. for 30 minutes to simultaneously dry the multilayer coating film, thereby preparing a test plate (Table 8).

### Example 17

Step (1): The intermediate paint (C-2) was electrostatically applied to substrate 1 to a cured film thickness of 35 μm using a rotary-atomization bell coater, and heated at 140° C. for 30 minutes to allow the film to be crosslinked and cured.

Step (2): Subsequently, the transparent base paint (D-1) was electrostatically applied to the cured coating film to a cured film thickness of 10 μm using a rotary-atomization bell coater, and allowed to stand for 2 minutes.

Step (3): Further, the metallic base paint (A-1) was applied to the coating film to a film thickness of 1.0 μm on a dry coating film basis at a booth temperature of 23° C. and a humidity of 68% using a Robot Bell (produced by ABB). After being allowed to stand for 3 minutes, the film was allowed to stand at 80° C. for 3 minutes to form an uncured metallic base coating film.

Step (4): Subsequently, the transparent colored paint (B-11) was applied to the surface of the dry coating film to a film thickness of 35 μm on a dry coating film at a booth temperature of 23° C. and a humidity of 68% using a Robot Bell (produced by ABB). After the coating, the film was allowed to stand at room temperature for 7 minutes, and heated using a hot-air-circulation drying oven at 140° C. for 30 minutes to simultaneously dry the multilayer coating film, thereby preparing a test plate (Table 9).

### 8. Evaluation of Coating Films

The appearance and properties of the coating films of the test plates obtained as described above were evaluated. Tables 2 to 9 show the results.

### (1) Measurement of Chroma C*

Chroma C*15, C*25, and C*45 in the L*C*h* color space was determined from spectral reflectance of light illuminated at an angle of 45° with respect to the coating film and received at angles of 15°, 25°, 45°, 75°, and 110° deviated from the specular reflection light. The measurement was performed with a multi-angle spectrophotometer (produced by X-Rite, Inc.; trade name: MA-68II).

### (2) Measurement of Lightness L*

Lightness L*15, L*25, and L*45 in the L*a*b* color space was determined from spectral reflectance of light illuminated at an angle of 45° with respect to the coating film and received at angles of 15°, 25°, 45°, 75°, and 110° deviated from the specular reflection light. The measurement was performed with a multi-angle spectrophotometer (produced by X-Rite, Inc.; trade name: MA-68II).

### (3) Measurement of Hue Angle h

Tables 2 to 4, 6, 8, and 9 show hue angle h in the L*C*h color space chromaticity calculated from spectral reflectance of light illuminated at an angle of 45° with respect to the coating film, and received at an angle of 15° deviated from the specular reflection light. Measurement was performed with a multi-angle spectrophotometer (produced by X-Rite, Inc.; trade name: MA-68II).

### (4) Calculation of X and Y

X and Y were determined in accordance with the following equations.

X=C*45/L*45

Y=[(L*15)²+(C*15)²)]^{1/2}+[(L*25)²+(C*25)²)]^{1/2}

In Example 1, *15, C*25, and C*45 were 111.9°, 71.0°, and 34.4°, respectively, and L*15, L*25, and L*45 were 29.0°, 13.9°, and 3.3°, respectively.

In Example 8, L*15, L*25, and L*45 were 100.0°, 68.0°, and 52.0°, respectively, and L*15, L*25, and L*45 were 42.0°, 20.0°, and 10.0°, respectively.

In Example 9, L*15, L*25, and L*45 were 102.0°, 68.0°, and 42.0°, and L*15, L*25, and L*45 were 22.0°, 14.0°, and 4.7°, respectively.

TABLE 2

| | Example | | | | | | | | Comp. Ex. | | |
|---|---|---|---|---|---|---|---|---|---|---|---|
| | 1 | 2 | 3 | 4 | 5 | 6 | 7 | 8 | 1 | 2 | 3 |
| Substrate | 1 | 1 | 1 | 1 | 1 | 1 | 1 | 1 | 1 | 1 | 1 |
| Intermediate paint (C) | C-1 | C-1 | C-1 | C-1 | C-1 | C-1 | C-1 | C-1 | C-1 | C-1 | C-1 |
| Metallic base paint | A-1 | A-1 | A-1 | A-1 | A-1 | A-2 | A-1 | A-1 | A-1 | A-1 | A-3 |
| (A) | | | | | | | | | | | |
| Clear paint 1 (E) | E-1 | E-1 | E-1 | E-1 | E-1 | E-1 | E-1 | E-1 | E-1 | E-1 | E-1 |
| Transparent colored | B-1 | B-2 | B-3 | B-4 | B-5 | B-1 | B-6 | B-7 | B-8 | B-9 | B-1 |
| paint (B) | | | | | | | | | | | |
| Clear paint 2 (E) | E-1 | E-1 | E-1 | E-1 | E-1 | E-1 | E-1 | E-1 | E-1 | E-1 | E-1 |
| X value | 10 | 12 | 5 | 10 | 10 | 12 | 5 | 4 | 10 | 0.5 | 5 |
| Y value | 188 | 150 | 190 | 170 | 180 | 190 | 160 | 179 | 20 | 200 | 48 |
| Optical density of | 75 | 150 | 45 | 75 | 75 | 75 | 75 | 75 | 225 | 15 | 75 |
| blue pigment in blue | | | | | | | | | | | |
| coating film | | | | | | | | | | | |
| Blue coating film | 15 | 15 | 15 | 15 | 15 | 15 | 15 | 15 | 15 | 15 | 15 |
| thickness (μm) | | | | | | | | | | | |
| Hue angle h (°) | 297 | 305 | 290 | 297 | 295 | 297 | 295 | 282 | 308 | 289 | 297 |

TABLE 3

| | Example | | | | | Comp. Ex. | |
|---|---|---|---|---|---|---|---|
| | 9 | 10 | 11 | 12 | 13 | 4 | 5 |
| Substrate | 1 | 1 | 1 | 1 | 1 | 1 | 1 |
| Intermediate paint (C) | C-2 | C-2 | C-2 | C-2 | C-2 | C-2 | C-2 |
| Base paint (D) | D-1 | D-1 | D-1 | D-1 | D-1 | D-1 | D-1 |
| Metallic base paint (A) | A-1 | A-1 | A-1 | A-1 | A-1 | A-1 | A-1 |
| Clear paint 1 (E) | E-1 | E-1 | E-1 | E-1 | E-1 | E-1 | E-1 |
| Transparent colored | B-1 | B-2 | B-3 | B-4 | B-5 | B-8 | B-9 |
| paint (B) | | | | | | | |
| Clear paint 2 (E) | E-1 | E-1 | E-1 | E-1 | E-1 | E-1 | E-1 |
| X value | 10 | 12 | 5 | 10 | 10 | 10 | 1.2 |
| Y value | 188 | 150 | 190 | 170 | 180 | 20 | 180 |
| Optical density of | 75 | 150 | 45 | 75 | 75 | 225 | 15 |
| blue pigment in blue | | | | | | | |
| coating film | | | | | | | |
| Blue coating film | 15 | 15 | 15 | 15 | 15 | 15 | 15 |
| thickness (μm) | | | | | | | |
| Hue angle h (°) | 297 | 305 | 290 | 297 | 295 | 308 | 289 |

TABLE 4

| | Example 14 |
|---|---|
| Substrate | 1 |
| Intermediate paint (C) | C-1 |
| Metallic base paint (A) | A-1 |
| Colored clear paint 1 | B-10 |
| Transparent colored paint (B) | B-1 |
| Colored clear paint 2 | B-10 |
| X value | 9 |
| Y value | 160 |
| Total optical density of blue | 105 |
| pigment in blue coating film | |
| Hue angle h (°) | 299 |

TABLE 5

| | | Transparent | |
|---|---|---|---|
| | | colored paint | |
| Coating film | Clear paint 2 | (B) | Clear paint 1 |
| Blue coating film | 35 | 15 | 25 |
| thickness (μm) | | | |
| Parts by mass | 0.5 | 5 | 0.5 |
| Optical density of | 17.5 | 75 | 12.5 |
| blue pigment in | | | |
| each coating film | | | |

TABLE 6

| | Example 15 |
|---|---|
| Substrate | 1 |
| Intermediate paint (C) | C-2 |
| Base paint (D) | D-1 |
| Metallic base paint (A) | A-1 |
| Colored clear paint 1 | B-10 |
| Transparent colored paint (B) | B-1 |
| Colored clear paint 2 | B-10 |
| X value | 9 |
| Y value | 160 |
| Total optical density of blue | 105 |
| pigment in blue coating film | |
| Hue angle h (°) | 299 |

TABLE 7

| | | Transparent | |
|---|---|---|---|
| | | colored paint | |
| Coating film | Clear paint 2 | (B) | Clear paint 1 |
| Blue coating film | 35 | 15 | 25 |
| thickness (μm) | | | |
| Parts by mass | 0.5 | 5 | 0.5 |
| Optical density of | 17.5 | 75 | 12.5 |
| blue pigment in | | | |
| each coating film | | | |

TABLE 8

| | Example 16 |
|---|---|
| Substrate | 1 |
| Intermediate paint (C) | C-1 |
| Metallic base paint (A) | A-1 |
| Transparent colored paint (B) | B-11 |
| X value | 12 |
| Y value | 160 |
| Total optical density of blue | 105 |
| pigment in blue coating film | |
| Blue coating film thickness/μm | 35 |
| Hue angle h (°) | 293 |

TABLE 9

| | Example 17 |
|---|---|
| Substrate | 1 |
| Intermediate paint (C) | C-2 |
| Base paint (D) | D-1 |
| Metallic base paint (A) | A-1 |
| Transparent colored paint (B) | B-11 |
| X value | 12 |
| Y value | 160 |
| Total optical density of blue | 105 |
| pigment in blue coating film | |
| Blue coating film thickness (μm) | 35 |
| Hue angle h (°) | 293 |

1. A multilayer coating film comprising
a metallic base coating film, and
a transparent colored coating film that contains a blue pigment and that is disposed on the metallic base coating film,
wherein
the value of hue angle h in an L*C*h color space diagram of the multilayer coating film is within the range of 225° to 300°, and
when X=C*45/L*45 and Y=[(L*15)²+(C*15)²)]^{1/2}+[(L*25)²+(C*25)²)]^{1/2}, X is 2 to 20 and Y is 50 to 250,
provided that C*15, C*25, and C*45 each represent a chroma of the multilayer coating film calculated from a spectral reflectance of light illuminated at an incident angle of 45° with respect to the multilayer coating film and received at angles of 15°, 25°, and 45° deviated from specular reflection light, and that L*15, L*25, and L*45 each represent a lightness of the multilayer coating film calculated from a spectral reflectance of light illuminated at an incident angle of 45° with respect to the multilayer coating film and received at angles of 15°, 25° and 45° deviated from specular reflection light.

2. The multilayer coating film according to claim 1, wherein X is 4 to 15 and Y is 100 to 200.

3. The multilayer coating film according to claim 1, wherein X is 9 to 12 and Y is 150 to 180.

4. The multilayer coating film according to claim 1, wherein the metallic base coating film contains an aluminum flake pigment, a surface-adjusting agent, and a rheology control agent.

5. The multilayer coating film according to claim 1, wherein the transparent colored coating film contains a resin component, and 0.5 to 10 parts by mass of the blue pigment per 100 parts by mass of resin solids of the transparent colored coating film.

6. The multilayer coating film according to claim 1, further comprising a clear coating film on the transparent colored coating film.

7. An object comprising the multilayer coating film of claim 1.

8. A method for forming a multilayer coating film comprising the following steps (1) to (3):
step (1) of applying a metallic base paint to a substrate to form a metallic base coating film,
step (2) of applying a transparent colored paint that contains a blue pigment to the metallic base coating film to form a transparent colored coating film that contains the blue pigment, and
step (3) of separately or concurrently heating the metallic base coating film formed in step (1) and the transparent colored coating film that contains the blue pigment formed in step (2) to cure the coating films,
wherein
the value of hue angle h in an L*C*h color space diagram of the multilayer coating film is within the range of 225° to 300°, and
when X=C*45/L*45 and Y=[(L*15)²+(C*15)²)]^{1/2}+[(L*25)²+(C*25)²)]^{1/2}, X is 2 to 20 and Y is 50 to 250,
provided that C*15, C*25, and C*45 each represent a chroma of the multilayer coating film calculated from a spectral reflectance of light illuminated at an incident angle of 45° with respect to the multilayer coating film and received at angles of 15°, 25°, and 45° deviated from specular reflection light, and that L*15, L*25, and L*45 each represent a lightness of the multilayer coating film calculated from a spectral reflectance of light illuminated at an incident angle of 45° with respect to the multilayer coating film and received at angles of 15°, 25° and 45° deviated from specular reflection light.

9. The method for forming a multilayer coating film according to claim 8, wherein the metallic base paint contains water, 0.2 to 6 parts by mass of an aluminum flake pigment on a solids basis per 100 parts by mass of the metallic base paint, a surface-adjusting agent, and a rheology control agent.

10. The method for forming a multilayer coating film according to claim 8, wherein the blue pigment has a haze value of 0 to 50.

11. The method for forming a multilayer coating film according to claim 8, wherein after being cured, the metallic base coating film has a film thickness of 0.02 to 5 μm.
